(19) United States
(12) Patent Application Publication
(10) Pub. No.: US 2025/0045751 A1
(43) Pub. Date: Feb. 6, 2025

(54) UNIVERSAL PAYMENT CHANNEL SYSTEM AND METHOD

(71) Applicant: Visa International Service Association, San Francisco, CA (US)

(72) Inventors: Mohammad Mohsen Minaei Bidgoli, San Jose, CA (US); Ranjit Kumaresan, Fremont, CA (US); Yibin Yang, Miami, FL (US); Srinivasan Raghuraman, Cambridge, MA (US); Mahdi Zamani, Mercer Island, WA (US); Mihai Christodorescu, Belmont, CA (US); Wanyun Gu, Menlo Park, CA (US)

(73) Assignee: Visa International Service Association, San Francisco, CA (US)

(21) Appl. No.: 18/716,450

(22) PCT Filed: Dec. 9, 2022
(86) PCT No.: PCT/US2022/081278

§ 371 Date: Jun. 4, 2024

Related U.S. Application Data
(60) Provisional application No. 63/288,425, filed on Dec. 10, 2021.

(51) Int. Cl. G06Q 20/40; G06Q 20/02; G06Q 20/38; H04L 9/08; H04L 9/32

(52) U.S. Cl. CPC G06Q 20/401; G06Q 20/02; G06Q 20/3825; G06Q 20/3827; G06Q 20/3829; H04L 9/0825; H04L 9/3247; G06Q 2220/10; H04L 2209/56

(57) ABSTRACT

A hub computer receives, from a first computer, a sender message comprising a promise corresponding to a transaction comprising a promise type, an amount, a first verification key associated with the first computer, computer code, and a digital signature. The hub computer verifies the promise by at least verifying the digital signature using the first verification key, verifying that the amount is less than a first computer amount, and verifying that the hub computer is able to process the promise type. The hub computer executes the computer code to perform the transaction.

### CROSS-REFERENCES TO RELATED APPLICATIONS

This application claims the benefit of U.S. Provisional Application No. 63/288,425, filed Dec. 10, 2021, which is herein incorporated by reference in its entirety for all purposes.

### BACKGROUND

One approach to improving the speed of blockchain transactions involves the creation of bilateral, off-chain channels, known as state channels. Such state channels are used by cryptocurrencies such as Ethereum. While such channels are useful, current off-chain channels cannot allow parties to perform different types of interactions that utilize arbitrary conditions without going on-chain. Such ability is important for scaling off-chain channels via a hub-and-spoke model, where each party establishes a channel with a highly available (but untrusted) hub without a priori knowledge about the type and conditions of its off-chain transactions.

Embodiments of the disclosure address this problem and other problems individually and collectively.

### SUMMARY

One embodiment is related to a method comprising: receiving, by a hub computer from a first computer, a sender message comprising a promise corresponding to a transaction comprising a promise type, an amount, a first verification key (e.g., a first public key) associated with the first computer, computer code, and a digital signature; verifying, by the hub computer, the promise by at least verifying the digital signature using the first verification key, verifying that the amount is less than a first computer amount, and verifying that the hub computer is able to process the promise type; and in response to verifying, executing the computer code to perform the transaction.

Another embodiment is related to a hub computer comprising: a processor; and a computer-readable medium coupled to the processor, the computer-readable medium comprising code executable by the processor for implementing a method comprising: receiving from a first computer, a sender message comprising a promise corresponding to a transaction comprising a promise type, an amount, a first verification key associated with the first computer, computer code, and a digital signature; verifying the promise by at least verifying the digital signature using the first verification key, verifying that the amount is less than a first computer amount, and verifying that the hub computer is able to process the promise type; and in response to verifying, executing the computer code to perform the transaction.

Another embodiment is related to a method comprising: establishing, by a first computer, an interaction channel with a hub computer, wherein the interaction channel corresponds to a channel contract; generating, by the first computer, a sender message comprising a first promise corresponding to a transaction comprising a promise type, an amount, a first verification key associated with the first computer, computer code, and a digital signature; and providing, by the first computer, the sender message to the hub computer, wherein the hub computer verifies the promise, executes the computer code to perform the transaction.

Further details regarding embodiments of the disclosure can be found in the Detailed Description and the Figures.

### BRIEF DESCRIPTION OF THE DRAWINGS

FIG. 1 shows a block diagram of an interaction channel system according to embodiments.

FIG. 2 shows a block diagram of components of a hub computer according to embodiments.

FIG. 3 shows a block diagram of components of a service provider computer according to embodiments.

FIG. 4 shows a flow diagram illustrating a registration method according to embodiments.

FIG. 5 shows a flow diagram illustrating a channel formation method according to embodiments.

FIG. 6 shows a flow diagram illustrating a promise creation method according to embodiments.

FIG. 7 shows a flow diagram illustrating an interaction completion method according to embodiments.

FIG. 8 shows a block diagram of a universal payment channel system according to embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a client in some embodiments.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “digital wallet” may include an electronic device or service that allows an individual to conduct electronic commerce transactions. A digital wallet may store user profile information, credentials, bank account information, one or more digital wallet identifiers and/or the like and can be used in a variety of transactions, such as, but not limited to, eCommerce transactions, social network transactions, money transfer/personal payment transactions, mobile commerce transactions, proximity payment transactions, gaming transactions, etc. A digital wallet may be designed to streamline the purchase and payment process. A digital wallet may allow the user to load one or more payment cards onto the digital wallet so as to make a payment without having to enter an account number or present a physical card. Digital wallets may also be used manage cryptocurrencies and execute cryptocurrency transactions, including, for example, receiving cryptocurrencies at a cryptocurrency address associated with the digital wallet holder or transmitting cryptocurrencies to other cryptocurrency addresses.

A “key pair” may include a pair of linked cryptographic keys. For example, a key pair can include a public key and a corresponding private key. As an example, in a key pair, a first key (e.g., a public key) may be used to encrypt a message, while a second key (e.g., a private key) may be used to decrypt the encrypted message. Additionally, a public key may be able to verify a digital signature generated with the corresponding private key. The public key may be distributed throughout a network in order to allow for verification of messages signed using the corresponding private key. Public and private keys may be in any suitable format, including those based on RSA or elliptic curve cryptography (ECC). In some embodiments, a public key of a public/private key pair may be a used as a service provider identifier that identifies a service provider. A public key can be a verification key.

A “digital signature” may include an electronic signature for a message. A digital signature may be a numeric data value, an alphanumeric data value, or any other type of data. In some embodiments, a digital signature may be a unique data value generated from a message (or data packet) and a private key using a cryptographic algorithm. In some embodiments, a validation algorithm using a public key may be used to verify the signature. A digital signature may be used to demonstrate the veracity of the sender.

A “hash” or “hash value” may include any data element produced using a “hashing function.” A hashing function may be used to transform data of arbitrary size to data of fixed size (e.g., 1 KB, 10 alphanumeric characters, etc.). A hash function may be used to generate commitments to secret data, such as a secret token, without revealing the secret data itself. Some hash functions are “collision resistant,” meaning it is difficult to determine two inputs that produce the same hash output. Collision resistant hash functions can be used as a security feature in blockchains.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “blockchain” can be a distributed database that maintains a continuously-growing list of records secured from tampering and revision. A blockchain may include a number of blocks of interaction records. Each block in the blockchain can contain also include a timestamp and a link to a previous block. Stated differently, interaction records in a blockchain may be stored as a series of “blocks,” or permanent files that include a record of a number of interactions occurring over a given period of time. Blocks may be appended to a blockchain by an appropriate node after it completes the block and the block is validated. Each block can be associated with a block header. In embodiments of the invention, a blockchain may be distributed, and a copy of the blockchain may be maintained at each full node in a verification network. Any node within the verification network may subsequently use the blockchain to verify interactions.

A “node” may be a point at which lines or pathways intersect or branch or can be a central or connecting point. A node can also be a “computer node,” which can be any computer or device that connects to the verification network. A node that can fully verify each block and interaction in the blockchain can be a full node. A “full node” can store the full blockchain (i.e., each block and each interaction). In some embodiments, a “user device” may be a computer node in a verification network.

A “block header” can be a header including information regarding a block. A block header can be used to identify a particular block of a blockchain. A block header can comprise any suitable information, such as a previous hash, a Merkle root, a timestamp, and a nonce. In some embodiments, a block header can also include a difficulty value.

A “nonce” can include an arbitrary number. In some embodiments, a nonce can be a value that can be adjusted by a full node while performing a proof-of-work process. A nonce can be input into a hash function along with block data to determine the output hash value. A correct nonce (also referred to as a golden nonce) yields an output hash value that satisfies a predetermined criteria, such as being less than a difficulty value. A nonce can be of any suitable length (e.g., 32-bits).

An “off-chain channel” or “interaction channel” may include a channel used to perform transactions or micro-transactions without broadcasting results to other devices. An example of an interaction channel can be a “state channel.” An off-chain channel can be performed without broadcasting results to a blockchain. An off-chain channel may be referred to as a “layer two channel.” Channels in the Lightning Network are examples of off-chain channels. In some implementations, an off-chain channel may be implemented utilizing a smart contract deployed on the blockchain. The participants on the off-chain channel can then perform transactions with one another without broadcasting to the blockchain. The off-chain channel can be closed by broadcasting “closing,” at which point the funds on the off-chain channel are distributed to the participants.

A “promise” may include an assurance that a particular thing will occur. In some embodiments, a promise may be used by a first user to interact with a second user, when the first user promises to provide an amount to the second user. A promise can also be used to initiate an interaction between two users via a hub computer. In some embodiments, a promise can include data that indicates for a first user to transfer a first amount of a first digital currency to a second user. For example, a promise can include data associated with the proposed interaction, a smart contract, and an interaction channel used to perform the interaction. In some cases, a promise can be included in a list of promises of a smart contract.

In embodiments, a promise can include data such as a channel identifier that identifies the interaction channel to be used for the interaction, a promise type, a first verification key associated with a first computer, a second verification key associated with a second computer, computer code (e.g., bytecode), a contract status of the interaction channel (e.g., “Active,” “Closed,” etc.), an index variable, a client credit variable that tracks the amount of digital currency held by a client, an amount (e.g., an amount of digital currency to be transferred from the first user to the second user), a hash value formed from an underlying secret, an expiry time after which the promise can no longer be claimed, a secret received indicator, and a digital signature formed using the previously mentioned variables.

A “promise type” can include a category of promise. A promise type can indicate what category of promise is being made. A promise type can be included in a promise. A promise type can be a value, such as an integer, an enum, a string, etc. that can be read by a device to determine the type of the promise.

“Computer code” can include a sequence or set of instructions in a programming language. Computer code can be executed by a computer to perform functionality. Computer code can include source code, bytecode, machine code, etc.

“Bytecode” can include computer object code. In embodiments, bytecode can be converted into binary machine code, by an interpreter, so that the code can be read by a computer's hardware processor. In some cases, bytecode can include compact numeric codes, constants, and references (normally numeric addresses) that encode a result of a compiler parsing and performing semantic analysis of things like type, scope, and nesting depths of program objects of a program's source code. Bytecode eliminates the need to recompile source code for each target platform. Even though interpreters differ between platforms, the application's bytecode does not.

For example, a developer can build an application in a high-level, human-readable programming language such as Java, C # or Python. A high-level language helps to simplify and optimize the application development process. However, the language statements (e.g., source code) cannot be read by a computer processor. A compiler converts the source code to bytecode. The bytecode can be an intermediary code that bridges the gap between the high-level source code and low-level machine code. The compiler is a special type of program that translates statements in the source code to bytecode, machine code, or another programming language.

A “smart contract” can include a computer program or protocol that performs functionality. A smart contract can automatically execute, control, or document relevant events and actions according to the terms of a contract or an agreement. A smart contract can expose functions that are callable by other devices (e.g., using an API). A smart contract can be stored in memory and/or on a blockchain.

A “hashed timelock contract” (HTLC) can include a type of smart contract. A hashed timelock contract can be a smart contract that utilizes a hashlock and a timelock. A hashed timelock contract can include conditional code that, when executed, allows two devices to establish an expiry time and a hashlock that can be unlocked using a secret. For example, a device receiving funds in a transaction can perform two actions to access the funds from the hashed timelock contract: 1) enter the correct secret and 2) claim payment within a specific timeframe.

A “secret” can include data that is not meant to be widely known. In some embodiments, a secret can be data or a value, and can be stored by a single computer until revealed to other computers. In some cases, a secret can be used to resolve a hashed timelock contract or other hashing verification method. As an example, prior to an interaction, a second computer can generate a random value to be a secret. The second computer can hash the secret and provide the hash value to a first computer. Later, the second computer can provide the secret to the first computer to complete the interaction. The first computer can determine a derived hash value from the secret and compare the derived hash value to the hash value to determine if the interaction is to be finalized.

A “receipt” may include an indication that something is being received. In embodiments, a receipt may be used to claim a promise. A receipt can include data associated with a smart contract and an interaction channel. For example, if a promise includes a proposed interaction amount, where a client credit is proposed to be increased by the interaction amount, then the receipt may include an updated client credit that includes the interaction amount. In some cases, a receipt can indicate that an interaction has been finalized. A receipt can be included in a list of receipts of a smart contract.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue credentials stored on a user device to the user.

An “accumulator” can include a set of data. In some embodiments, an accumulator can condense a set of values into a smaller data object, such that there is a witness value for each value included in the condensed set of values. It can be infeasible to find a witness for a value that has not been accumulated in the accumulator. A Merkle tree can be an example of an accumulator, which is a cryptographic primitive that lets one commit to a set of values, and later prove that a particular value is a member of the set of values. An accumulator can also be an RSA-based accumulator.

“Executing” can include carrying out or putting into effect a program. A computer can execute computer code to carry out or put into effect the computer code. For example, executing computer code can include starting to process computer code, where the computer code can be processed at once or over time. Execution can be a process by which a computer reads and acts on the instructions of a computer program.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments provide for interaction channels that allow two devices to agree on a smart contract off-chain (e.g., a promise contract) that specifies the conditions on which interactions can happen. If either party violates any of the terms, the other party can later deploy the promise contract on-chain as needed to receive a remedy as agreed upon in the smart contract. Specifically, embodiments provide for interactions where only one device deposits an amount to the agreed off-chain interaction contract, enabling lightweight interactions. Any smart contact between two or more devices can be implemented according to embodiments, which allows the devices to use their pre-deposited on-chain collaterals for any off-chain interactions. The off-chain interactions can include those that are not anticipated at the time that the interaction channel is set up. The security and correctness of embodiments under this framework are effective and proven. Further, protocols according to embodiments can be implemented on Ethereum using accumulators to achieve efficient concurrent programmable transactions, and the gas overhead of an HTLC smart contract can be measured to be <100K, which can be amortized over many off-chain interactions.

Currently, institutions offer a variety of services such as payments, loans, trading, etc., to users. These services heavily rely on some metrics of trustworthiness that allow an institution and their client to engage in interactions while minimizing risk in case either party fails to meet certain requirements that protect both parties' interests. These requirements are usually specified as a mutual contract agreed upon by both parties, allowing the suffering party to collect all or a portion of the other party's assets as a remedy in case of failure. With the rise of decentralized services, such services can be offered on blockchains with higher security and lower operational costs. With its ability to run arbitrary programs, called smart contracts, and direct access to assets, a blockchain can execute complex contracts and can automatically settle disputes. Unfortunately, these benefits come with major scalability technical challenges due to the overhead of on-chain interactions, preventing the adoption of such methods and systems.

Payment channels are a class of mechanisms for scaling blockchain interactions, by “off-loading” interactions to an off-chain communication channel between two interacting devices. The channel is “opened” via an on-chain interaction to fund the channel, followed by any number of off-chain interactions. Eventually, by a request from either or both devices, the channel is “closed” via another on-chain interaction. This design avoids technical problems of the costs and the latency associated with on-chain operations, effectively amortizing the overhead of on-chain interactions over many off-chain interactions. While several proposals improve the scalability of such interaction channels, they do not allow imposing arbitrary conditions on off-chain interactions.

Such arbitrary conditions can include fractional payments (e.g., a user pays a second user a maximum of $10 if the interaction is claimed in 1 hour, but only $5 if the interaction is claimed thereafter), reservation cancellation (e.g., a user can be returned a promised amount if they attempt to cancel a hotel reservation prior to a time based deadline), an amount match between parties up to a predetermined total amount (e.g., a user promises to buy up to a total amount of gas ($100) from a gas station, but only ends up using a portion of the total amount of gas ($75). The user can be refunded the remaining ($25) amount that was not used on gas), and/or any other condition that can be implemented in computer code (e.g., auctions, option purchases, put calls, etc.).

State channels allow two devices to perform general purpose computation off-chain by mutually tracking the current state of the program. Existing state channel proposals have at least two technical problems.

A first technical problem is that they require the interacting devices to fix (e.g., establish and not change) the program, which they wish to run off-chain, at the time of channel setup. This means that no changes to the program are allowed after the devices go off-chain. This is especially problematic in off-chain scalability approaches based on the hub-and-spoke model. In the hub-and-spoke model, each device establishes a general-purpose channel with a highly available, but untrusted, hub computer during setup to be able to later interact with many other parties without the need to establish an individual channel with each device. In practice, devices usually have no a priori knowledge about specific sets of conditions needed to interact with other devices with which they have no relationship.

A second technical problem is that existing state channel proposals are overly complex and resource intensive, even for simple, programmable interactions. The authorization of an off-chain interaction via an interaction channel can be made less resource intensive since as the flow of the payments is usually unidirectional (e.g., from a sender to a receiver) while state channels need to track all state changes from both devices irrespective of the payment direction.

Embodiments introduce a notion of programmable payment channels (PPC) that allow devices to agree, off-chain, on a set of conditions (e.g., in a smart contract) that the devices are attempting to impose for their off-chain interactions. An example of such a program is a hash-time-locked contract (HTLC). Interaction channel networks utilize HTLCs to provide trustless routing of interactions across a network.

While current channels already embed HTLCs for routing, many useful applications remain difficult to build on top of these interaction channels. For example, consider the following simple programmable interaction example. A first user utilizing a user device, Alice, wants to reserve a room through an established interaction channel with a hotel. Alice would like to send an interaction under the following conditions: (1) Alice is allowed to cancel the reservation within 48 hours of booking to get back all of her funds, and (2) Alice can get back half of her funds if she cancels the reservation within 24 hours of the stay date. Conducting this simple example with current payment channels and HTLCs is either inefficient or impossible. Technical solutions to these and other technical problems with be described herein.

Embodiments utilize contracts on blockchains that are allowed and capable of deploying new contracts at deterministic addresses. For example, Ethereum introduced the opcode CREATE2 in EIP-10142. Embodiments can utilize the above feature to achieve general programmability. In Ethereum, using the CREATE2 opcode, contracts deploy contracts whose address is set by H (0xFF, sender, salt, bytecode) (where H is a hash function; which is replaced by a random oracle denoted by RO herein). This capability implies that an address of some yet-to-be-deployed contract can be foreseen. This property is dubbed as “prescience.”

Embodiments provide for promises that represent a single instance of a programmable payment which is written as a contract that can be deployed on-chain by the PPC contract (e.g., interaction channel contract). Embodiments utilize the PPC contract to determine whether a promise should be deployed. The PPC contract can authenticate the payer and sender via digital signatures. After deploying the promise, to fast-forward to the last agreed off-chain execution state, embodiments require both parties' signatures on the latest state. This mechanism is embedded into the promise contract.

Promises can be deployed on-chain (e.g., on a blockchain network) whenever a dispute arises, and the process can continue on-chain via the newly deployed contract. However, when both devices are honest, the entire execution can be handled off-chain.

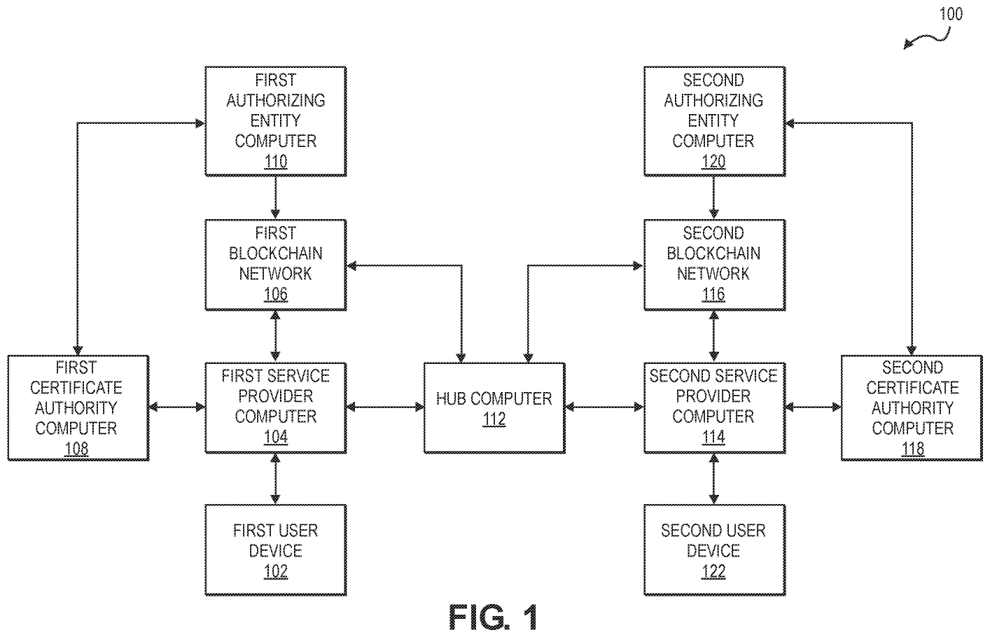

FIG. 1 shows a system 100 according to embodiments of the disclosure. The system 100 comprises a first user device 102, a first service provider computer 104 (an example of a first computer), a first blockchain network 106, a first certificate authority computer 108, a first authorizing entity computer 110, a hub computer 112, a second service provider computer 114 (an example of a second computer), a second blockchain network 116, a second certificate authority computer 118, a second authorizing entity computer 120, and a second user device 122.

The first user device 102 can be in operative communication with the first service provider computer 104. The first service provider computer 104 can be in operative communication with the first blockchain network 106, the first certificate authority computer 108, and the hub computer 112. The first blockchain network 106 can be in operative communication with the first authorizing entity computer 110 can the hub computer 112. The first certificate authority computer 108 can be in operative communication with the first authorizing entity computer 110. The hub computer 112 can be in operative communication with the second blockchain network 116 and the second service provider computer 114. The second service provider computer 114 can be in operative communication with the second user device 122, the second certificate authority computer 118, and the second blockchain network 116. The second blockchain network 116 can be in operative communication with the second authorizing entity computer 120. The second authorizing entity computer 120 can be in operative communication with the second certificate authority computer 118.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between at least the devices included in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The first authorizing entity computer 110 and the second authorizing entity computer 120 can be operated by a first authorizing entity and a second authorizing entity respectively. In some embodiments, the first authorizing entity and the second authorizing entity can be the same entity. In some embodiments, the first and second authorizing entity computers can be issuing bank computers.

The first certificate authority computer 108 and the second certificate authority computer 118 can be operated by the same or different certificate authorities. In some embodiments, the first certificate authority computer 108 and the second certificate authority computer 118 can be computers that are operated by banks, payment processors, or other entities.

The first blockchain network 106 may operate a first blockchain of a first digital currency. The second blockchain network 116 may operate a second blockchain of a second digital currency. The first and second digital currencies may be the same or different. In some embodiments, the first blockchain network 106 may be operated or used by the first authority entity, and the second blockchain network 116 may be operated or used by the second authorizing entity.

The first service provider computer 104 may be operated by a first service provider. The first service provider may provide access to a digital wallet to users. For example, the first service provider computer 104 may be a digital wallet application server and may communicate with digital wallet applications installed on user devices. The second service provider computer 114 may be operated by a second service provider, and may be similar to the first service provider computer 104. The first user device 102 may be operated by a first user, and the second user device 122 may be operated by a second user. The hub computer 112 may be operated by a processing network, such as a payment processing network.

As an example of the system 100, the first authorizing entity computer 110 can manage accounts on behalf of users. The accounts can include a first digital currency, which can be a central bank digital currency (CBDC), a cryptocurrency, a fiat currency, etc. The first authorizing entity computer 110 may delegate key provisioning for using and/or accessing the account to the first certificate authority computer 108. The first certificate authority computer 108 may provide a key pair (e.g., through a digital certificate) that can be used to access the first blockchain network 106 to the first service provider computer 104. The first service provider computer 104 may then access or interact with the first blockchain network 106 using a received verification key (e.g., public key) of the key pair.

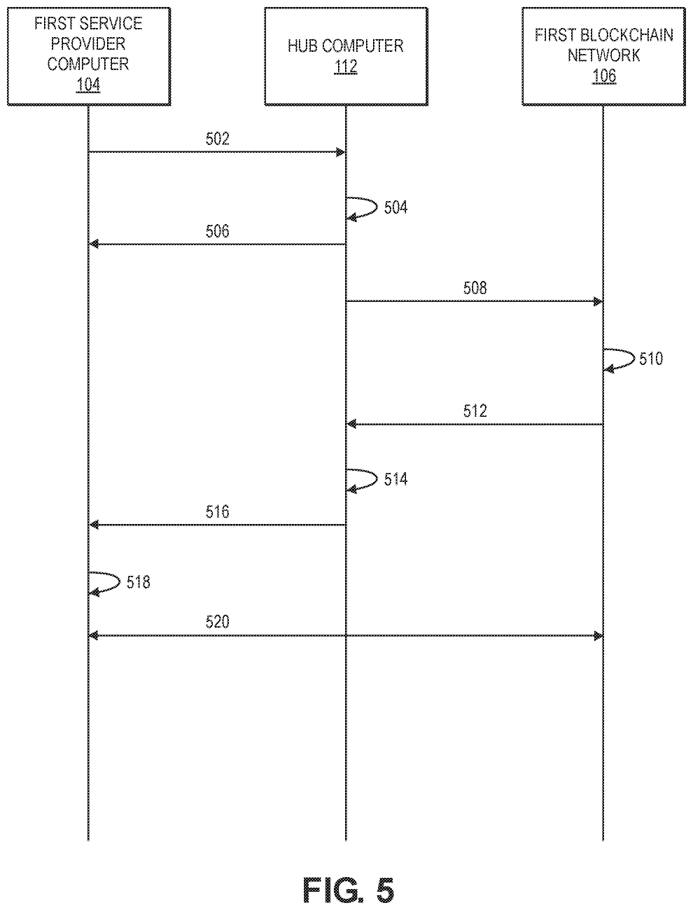

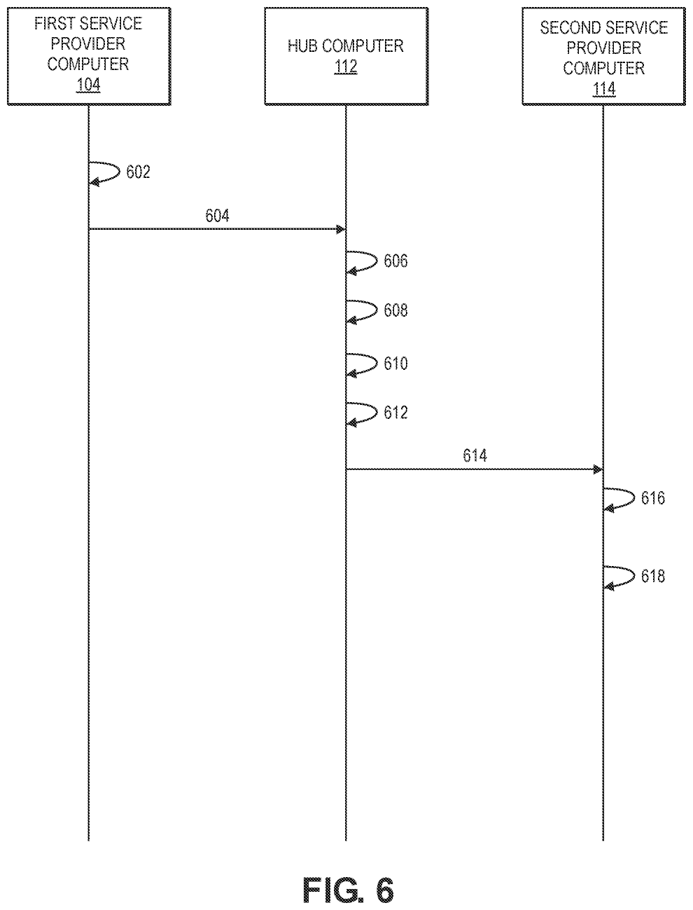

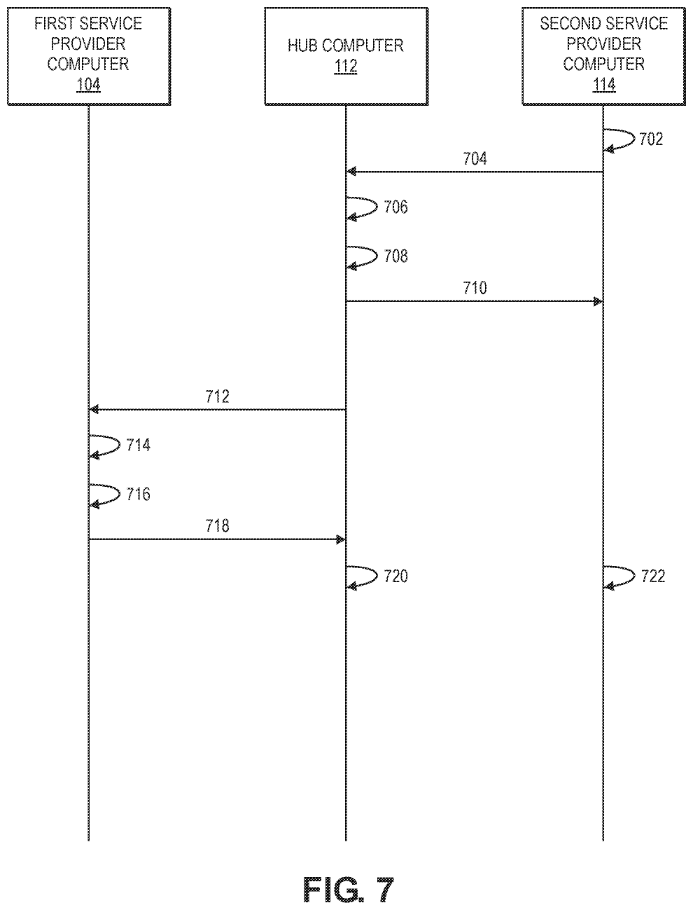

Once the first service provider computer 104 receives the key pair from the first certificate authority computer 108, the first service provider computer 104 may then provide digital currency accounts to user devices. For example, the first service provider computer 104 can provide a digital currency account to the first user device 102. For example, the first user may install a digital wallet application on the first user device 102, which is used to obtain a digital currency account. After obtaining the digital currency account, the first user device 102 may communicate with the first blockchain network 106 via the first service provider computer 104. The first service provider computer 205 may open an interaction channel using a channel contract with the hub computer 112 on the first blockchain network 106 (e.g., as described in reference to FIG. 5). The interaction channel can facilitate the first service provider computer 104 in communicating and performing interactions (e.g., off-chain, on-chain, cross-chain transfers, etc.) on behalf of the first user device 102 directly with the hub computer 112, without accessing the first blockchain network 106. For example, the interaction channel can allow the first service provider computer 104 to generate a promise to provide an amount to the second service provider computer 114 via the hub computer 112 (e.g., as described in reference to FIG. 6). The interaction channel can further allow the second service provider computer 114 to generate a secret to obtain the amount included in the promise (e.g., as described in reference to FIG. 7).

A similar process can be performed between the second authorizing entity computer 120, the second certificate authority computer 118 (e.g., to provide a public key that acts as a second service provider identifier), the second blockchain network 116, the second service provider computer 114, the second user device 122, and the hub computer 112 to establish a second interaction channel between the second service provider computer 114 and the hub computer 112. After the second interaction channel is established between the second service provider computer 114 and the hub computer 112, the hub computer 112 may be separately in communication with the first blockchain network 106 and the second blockchain network 116, and the first service provider computer 104 via a first interaction channel and the second service provider computer 114 via the second interaction channel.

In some embodiments, the first service provider computer 104 and the hub computer 112 can establish an interaction channel, and the hub computer 112 does not have to operate as an intermediary between a first service provider computer 104 and a second service provider computer 114. The hub computer 112 and the first service provider computer 104 can form a state channel to conduct interactions between then without an additional party.

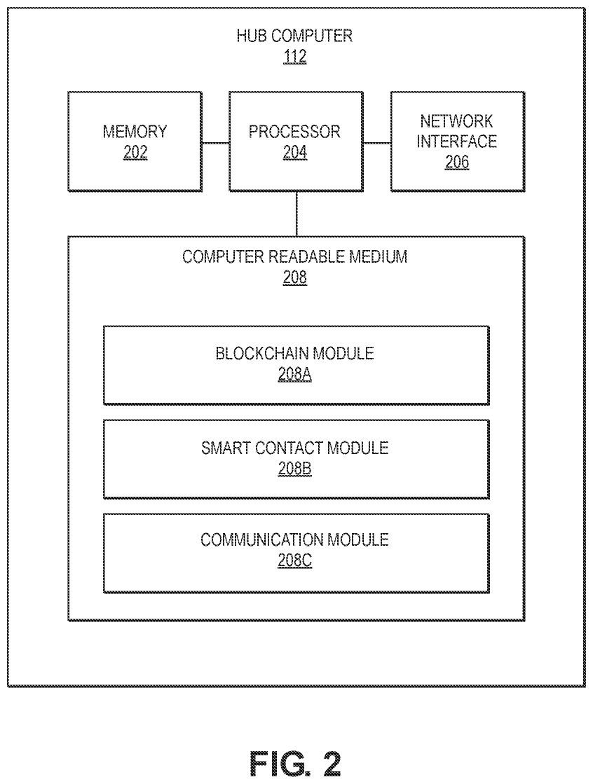

FIG. 2 shows a block diagram of the hub computer 112 according to embodiments. The exemplary hub computer 112 may comprise a processor 204. The processor 204 may be coupled to a memory 202, a network interface 206, and a computer readable medium 208. The computer readable medium 208 can comprise a blockchain module 208A, a smart contract module 208B, and a communication module 208C.

The memory 202 can be used to store data and code. For example, the memory 202 can store a hub computer public key, a hub computer private key, smart contracts, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving from a first computer, a sender message comprising a promise corresponding to a transaction comprising a promise type, an amount, a first verification key associated with the first computer, computer code, and a digital signature; verifying the promise by at least verifying the digital signature using the first verification key, verifying that the amount is less than a first computer amount, and verifying that the hub computer is able to process the promise type; and in response to verifying, executing the computer code to perform the transaction. Note that in embodiments, the execution of the computer code can occur to implement a number of steps in the method, or can occur during the performances of the steps in the method.

The blockchain module 208A may comprise code or software, executable by the processor 204, for processing blockchain related data and communicating with blockchain networks. The blockchain module 208A, in conjunction with the processor 204, can utilize public/private key pairs used to communicate with a blockchain network. The blockchain module 208A, in conjunction with the processor 204, may establish communication channels, such as interaction channels on blockchains. An interaction channel can be governed by a channel contract. The blockchain module 208A, in conjunction with the processor 204, may transfer digital currencies on-chain and off-chain. In some embodiments, the blockchain module 208A, in conjunction with the processor 204, may allow the hub computer 112 to facilitate cross-chain interactions. In some cases, the blockchain module 208A, in conjunction with the processor 204, can initiate the creation of a transaction entry in a block in a blockchain of a blockchain network.

The smart contract module 208B may comprise code or software, executable by the processor 204, for deploying and maintaining smart contracts. The smart contract module 208B, in conjunction with the processor 204, can deploy smart contracts to blockchains. The smart contract module 208B, in conjunction with the processor 204, can access stored smart contracts and deploy the smart contracts to a blockchain using the blockchain module 208A. The smart contract module 208B, in conjunction with the processor 204, can invoke functions and protocols of a smart contract that is deployed on a blockchain.

The communication module 208C may comprise code or software, executable by the processor 204, for communicating with other devices. The communication module 208C, in conjunction with the processor 204, can generate messages, forward messages, reformat messages, and/or otherwise communicate with other devices.

The network interface 206 may include an interface that can allow the hub computer 112 to communicate with external computers. The network interface 206 may enable the hub computer 112 to communicate data to and from another device (e.g., service provider computers, blockchain networks, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

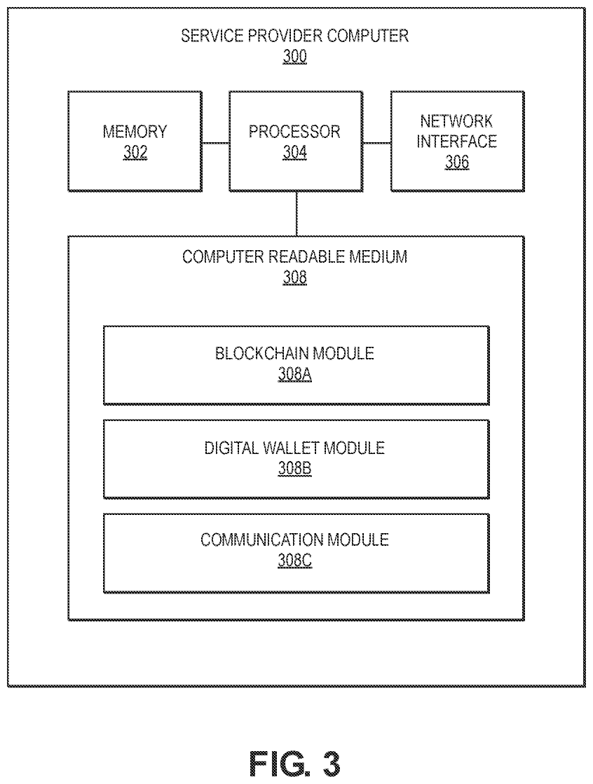

FIG. 3 shows a block diagram of a service provider computer 300 according to embodiments. The exemplary service provider computer 300 may comprise a processor 304. The processor 304 may be coupled to a memory 302, a network interface 306, and a computer readable medium 308. The computer readable medium 308 can comprise a blockchain module 308A, a digital wallet module 308B, and a communication module 308C.

The memory 302 can be used to store data and code and may be similar to the memory 202 as described herein. For example, the memory 302 can store verification keys, private keys, smart contracts, etc.

The computer readable medium 308 may comprise code, executable by the processor 304, for performing a method comprising: establishing, by a first computer, an interaction channel with a hub computer, wherein the interaction channel corresponds to a channel contract; generating, by the first computer, a sender message comprising a first promise corresponding to a transaction comprising a promise type, an amount, a first verification key associated with the first computer, computer code, and a digital signature; and providing, by the first computer, the sender message to the hub computer, wherein the hub computer verifies the promise, executes the computer code to perform the transaction.

The blockchain module 308A may comprise code or software, executable by the processor 304, for processing blockchain related data and communicating with blockchain networks. The blockchain module 308A, in conjunction with the processor 304, can utilize public/private key pairs used to communicate with a blockchain network. The blockchain module 308A, in conjunction with the processor 304, can allow the a user associated with a user account maintained by the service provider computer 300 to interact using amounts included in the user account. The blockchain module 308A, in conjunction with the processor 304, may transfer digital currencies on-chain and off-chain.

The digital wallet module 308B may comprise code or software, executable by the processor 204, for maintaining a digital wallet application server. The digital wallet module 308B, in conjunction with the processor 304, can communicate with a plurality of user devices running a digital wallet application. The digital wallet module 308B, in conjunction with the processor 304, can maintain digital wallet applications that provide access between the service provider computer 300 and user devices and allows user devices to interact using amounts included in accounts in the digital wallet.

The communication module 308C may comprise code or software, executable by the processor 304, for communicating with other devices. The communication module 308C, in conjunction with the processor 304, can generate messages, forward messages, reformat messages, and/or otherwise communicate with other devices.

The network interface 306 may be similar to the network interface 206 and will not be repeated here.

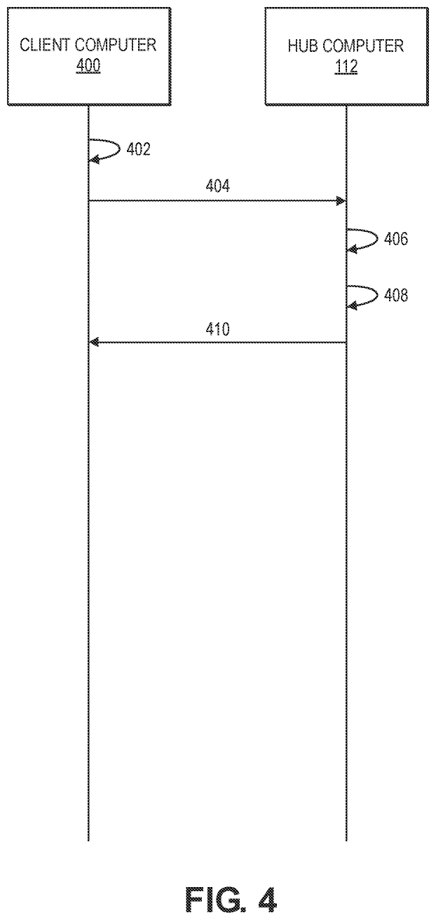

FIG. 4 shows a flow diagram illustrating a registration method according to embodiments. The method illustrated in FIG. 4 will be described in the context of a client computer 400 registering with the hub computer 112. The client computer 400 can register to participate in the interaction methods provided by the hub computer 112. The client computer 400 can be a service provider computer (e.g., the first service provider computer 104, the second service provider computer 114, etc.).

At step 402, the client computer 400 can obtain cryptographic key pair including a verification key and a secret key (e.g., a public cryptographic key and a private cryptographic key). The client computer 400 can generate the cryptographic key pair in any suitable cryptographically secure method. In some embodiments, the client computer 400 can obtain the cryptographic key pair from a certificate authority.

At step 404, after obtaining the verification key and the secret key, the client computer 400 can generate and provide a registration request message including the verification key to the hub computer 112. The registration request message can also include additional data that identifies the client computer 400 (e.g., a client computer identifier, etc.).

At step 406, after receiving the registration request message, the hub computer 112 can determine whether or not the client computer 400 is already registered. The hub computer 112 can access a stored registry list that includes a plurality of verification keys corresponding to client computers that are registered with the hub computer 112. The hub computer 112 can evaluate the registry list to determine if the registry list already includes the verification key. If the registry list already includes the verification key, then the client computer 400 has already been registered and the hub computer 112 can notify the client computer 400 that the client computer 400 is already registered. If the registry list does not include the verification key, then the client computer 400 can proceed with step 408.

At step 408, after determining that the client computer 400 has not yet been registered, the hub computer 112 can register the client computer 400. The hub computer 112 can register the client computer 400 by adding the verification key to the registry list.

At step 410, after adding the verification key to the registry list, the hub computer 112 can generate a registration response message that indicates that the client computer 400 is now registered. The hub computer 112 can provide the registration response message to the client computer 400.

FIG. 5 shows a flow diagram illustrating a channel formation method according to embodiments. The method illustrated in FIG. 5 will be described in the context of the first service provider computer 104 communicating with the hub computer 112 to deploy a smart contract (e.g., a UPC smart contract) to establish an interaction channel. The smart contract can govern the usage of the interaction channel. The smart contract for the interaction channel can be a channel contract.

After the description of the method illustrated in FIG. 5, Tables 1 and 2 are provided to illustrate details of the interaction channel and channel contract.

The channel deploy protocol can be used to deploy an interaction channel. The first service provider computer 104 may receive instructions from the first user device 102 to begin the channel deploy protocol. In some embodiments, the first service provider computer 104 and the hub computer 112 may agree on channel contract parameters prior to the channel deploy protocol, where the parameters include a channel identifier and a claim duration time. The channel identifier can be an alphanumeric value that uniquely identifies the interaction channel (e.g., 0001). The claim duration time can indicate how long the interaction channel will remain active (e.g., 4 hours).

At step 502, the first service provider computer 104 may transmit a request to open an interaction channel to the hub computer 112. The request to open an interaction channel can be a channel initiation request message. The channel initiation request message may include a channel identifier and a channel claim duration time used to deploy a channel contract. In some embodiments, the channel initiation request message may further include identifying data of the first service provider computer 104 (e.g., a verification key of the first service provider computer 104). In some embodiments, the channel initiation request message can indicate a particular blockchain for the interaction channel (e.g., with the user of a blockchain identifier). For example, the channel initiation request message can indicate for the interaction channel to utilize the first blockchain network 106.

At step 504, after receiving the channel initiation request message from the first service provider computer 104, the hub computer 112 may verify that the first blockchain network 106 is a supported blockchain network. For example, the hub computer 112 may verify that a communication channel has been established with the first blockchain network 106.

The hub computer 112 can then generate a request identifier for the received request. The request identifier can be utilized to identify and track the request to deploy the channel contract to initialize the interaction channel. For example, the request identifier may be used by the first service provider computer 104 to monitor the status of the interaction channel. The request identifier can be beneficial since the channel contract may not be immediately deployed on the first blockchain network 106. Therefore, the request identifier may be used by the first service provider computer 104 to query the hub computer 112 on the status of the first smart contract deployment.

At step 506, after initiating the deployment of the channel contract, the hub computer 112 may transmit the request identifier and the channel identifier to the first service provider computer 104.

At step 508, after providing the request identifier to the first service provider computer 104, the hub computer 112 can generate a channel contract deployment request message. The channel contract deployment request message can include the channel contract and a channel identifier. The channel contract deployment request message can also include the request identifier.

The hub computer 112 can provide the channel contract deployment request message to the first blockchain network 106. For example, the hub computer 112 may invoke a deploy contract function of the first blockchain network 106 to deploy the channel contract to the first blockchain network 106. As such, the hub computer 112 may transmit instructions to the first blockchain network 106 to run the deploy contract function using the channel contract code.

At step 510, after receiving the channel contract deployment request message, the first blockchain network 106 may run the deploy contract function(s). The channel contract can be in a block of a blockchain maintained by the first blockchain network 106. The first blockchain network 106 can obtain a contract identifier that identifies the location on the blockchain at which the channel contract is stored. The contract identifier may be an address of the channel contract on the first blockchain network 106.

At step 512, after obtaining the contract identifier, the first blockchain network 106 may generate a channel contract deployment response message comprising the contract identifier. The first blockchain network 106 can provide the channel contract deployment response message to the hub computer 112. In some embodiments, the hub computer 112 can deposit funds to the channel contract after the deployment of the channel contract.

At step 514, after receiving the channel contract deployment response message from the first blockchain network 106, the hub computer 112 can initialize the channel contract that is deployed to the blockchain of the first blockchain network 106. For example, the hub computer 112 can execute an initialization function included in the channel contract. For example, the hub computer 112 can initialize the channel contract using a hub computer verification key, the first service provider computer verification key, the channel identifier, and the claim duration time as input to the initialization function of the channel contract on the first blockchain network 106. The channel contract can process the received data to implement an interaction channel between the first service provider computer 104 and the hub computer 112, which can be identified by the channel identifier.

The channel contract can include data relating to the devices involved in the to be established interaction channel. For example, the channel contract can include data relating to the first service provider computer 104 and the hub computer 112. The channel contract can also include data related to interactions, promises, and receipts between the first service provider computer 104 and the hub computer 112.

The channel contract can initialize the interaction channel by setting a channel status to “active,” in contrast to a channel status of “closed.” The channel contract can also set an indication of channel expiry to indicate that the channel is not expired. In some embodiments, the channel contract can include the expiry date (e.g., Mar. 15, 2023). The channel contract can also create an empty object (e.g., list, queue, etc.) that includes unresolved promises. The channel contract can store data relating to the hub computer 112, including the hub computer verification key, a hub deposit amount (e.g., currently at $0), an index of the latest receipt submitted by the hub computer 112 (e.g., currently null or 0), a hub computer credit value (e.g., currently at $0), and a Boolean that indicates that the hub computer 112 has not closed the channel. The channel contract can store data relating to the first service provider computer 104, including the first service provider computer verification key, a first service provider computer deposit amount (e.g., currently at $0), an index of the latest receipt submitted by the first service provider computer 104 (e.g., currently null or 0), a first service provider computer credit value (e.g., currently at $0), and a Boolean that indicates that the first service provider computer 104 has not closed the channel.

The channel contract can also include the channel identifier that identifies the interaction channel (e.g., 0001), an indication of the ledger or blockchain that the channel contract resides on (e.g., an indication that the channel contract is on a blockchain maintained by the first blockchain networks 106), and the contract object itself that includes the code functionality (e.g., as depicted in Table 1).

The channel contract can include a list of ingoing promises (e.g., promises made by the first service provider computer 104 to the hub computer 112) and a list of outgoing promises (e.g., promises made by the hub computer 112 to the first service provider computer 104). The list of ingoing promises and the list of outgoing promises can be initialized as empty lists. As promises are generated, as described herein, the promises can be added to the relevant ingoing or outgoing promise list. The promise lists can include all promises, both pending and completed.

The channel contract can also include an ingoing accumulator and an outgoing accumulator. The ingoing accumulator and the outgoing accumulator can be data objects (e.g., cryptographic primitives) that store pending promises. As promises are generated, the promises can be added to the relevant ingoing or outgoing pending promises accumulator. The accumulators can be secure data objects that include pending promises and provide for efficient proofs of those pending promises being included in the accumulator. As promises are fulfilled (e.g., via receipts), the pending promises can be removed from the relevant accumulator.

The channel contract can also include a net ingoing promise amount and a net outgoing promise amount. The net ingoing promise amount and the net outgoing promise amount can aggregate the amounts included in generated promises. The net ingoing promise amount can be a total amount promised by the first service provider computer 104 to the hub computer 112. The net outgoing promise amount can be a total amount promised by the hub computer 112 to the first service provider computer.

The channel contract can also include a list of receipts that have been generated and registered with the interaction channel. A receipt can be an indication of completion of a promise. When a receipt is registered (e.g., added) to the interaction channel, the channel contract can update the list of receipts as well as other data entries (e.g., accumulators, credits, etc.) that depend upon the completed promise that corresponds to the receipt.

The amount of funds that a computer has in the interaction channel can be determined based on several of the aforementioned values included in the channel contract. For example, the total amount that the first service provider computer 104 has available for interactions can be determined based on of the first service provider computer deposit amount, the ingoing credit value (e.g., amount credited to the hub computer 112 by the first service provider computer 104), the outgoing credit value (e.g., amount credited to the first service provider computer 104 by the hub computer 112), the net ingoing promise value (e.g., amount promised to the hub computer 112 by the first service provider computer 104), and the net outgoing promise value (e.g., amount promised to the first service provider computer 104 by the hub computer 112). This total available amount for the first service provider computer 104 can be a first computer amount. The total available amount for the hub computer 112 can be a hub computer amount.

For example, during an interaction, the hub computer 112 can verify that an amount promised to the hub computer 112 by the first service provider computer 104 is less than the first computer amount. As such, the hub computer 112 can verify that the first service provider computer 104 has sufficient funds for the promise.

Table 1, below, includes an example of a channel contract (e.g., a UPC contract) and various functions of the channel contract. Table 2, below, includes details of variables included herein.

At step 516, after initializing the channel contract on the first blockchain network 106, the hub computer 112 may transmit the request identifier and the contract identifier to the first service provider computer 104.

At step 518, after receiving the request identifier and the contract identifier from the hub computer 112, the first service provider computer 104 may verify the deployment of the channel contract that implements the interaction channel. For example, the first service provider computer 104 may identify the channel contract on the blockchain using the contract identifier. The first service provider computer 104 can execute a get parameters function included in the channel contract to obtain parameters related to the interaction channel. For example, the first service provider computer 104 can execute an exposed function on the channel contract (e.g., a GetParams( ) function) and can receive output parameters. The parameters can include the channel identifier, the hub computer verification key, the first service provider computer verification key, and the claim duration time.

The first service provider computer 104 can verify the obtained parameters. For example, the first service provider computer 104 can verify that the channel identifier, the first service provider computer verification key, the hub computer verification key, and the claim duration time are equal to the correct values as known by the first service provider computer 104.

In some embodiments, the first service provider computer 104 may access the first blockchain network 106 using the contract identifier to retrieve the smart contract and, after verifying the parameters of the smart contract, can store the smart contract locally.

In some embodiments, at step 520, the first service provider computer 104 can communicate with the first blockchain network 106 using the channel identifier to verify that the channel contract is properly created and deployed to the first blockchain. For example, the first service provider computer 104 can verify that the channel contract is the correct contract. Furthermore, during step 520, the first service provider computer 104 can deposit and amount (e.g., funds) to the channel contract.

A similar process can be performed between the second blockchain network 116, the second service provider computer 114, and the hub computer 112 to deploy a channel contract to the second blockchain network 116 that implements a second interaction channel between the hub computer 112 and the second service provider computer 114. The interaction channel between the first service provider computer 104 and the hub computer 112 can be a first interaction channel associated with a first channel contract. The interaction channel between the second service provider computer 114 and the hub computer 112 can be a second interaction channel associated with a second channel contract.

TABLE 1
Example interaction channel contract

```
Init(cid′, vk′_{H}, vk′_{C}, claimDuration′):
  (a) Set (cid, claimDuration) ← (cid′, claimDuration′);
  (b) Set status ← “Active”; Set chanExpiry ← 0; unresolvedPromises ← ⊥;
  (c) Set hub ← {addr: vk′_{H}, deposit: 0, rid: 0, credit: 0, acc: ⊥, closed: F}
  (d) Set client ← {addr: vk′_{C}, deposit: 0, rid: 0, credit: 0, acc: ⊥, closed: F}
GetParams( ):
  Output [cid, hub. addr, client. addr, claimDuration].
Deposit(amount):
  (a) Require status = “Active” and caller. vk ∈ {hub. addr, client. addr};
  (b) If caller. vk = hub. addr, then set hub. deposit ← hub. deposit + amount;
  (c) If caller. vk = client. addr, then set client. deposit ← client. deposit + amount.
RegisterReceipt(R):
  (a) Require status ∈ {“Active”, “Closing”};
  (b) Require caller. vk ∈ {hub. addr, client. addr};
  (c) If caller. vk = hub. addr, then:
    i. Require SigVerify(R. σ, [cid, R. idx, R. credit, R. acc], client. addr);
    ii. Set hub. rid ← R. idx, hub. credit ← R. credit, and hub. acc ← R. acc;
    Otherwise:
    i. Abort if SigVerify(R. σ, [cid, R. idx, R. credit, R. acc], hub. addr);
    ii. Set client. rid ← R. idx, client. credit ← R. credit, and client. acc ←
    R. acc;
  (d) If status = “Active”, then set chanExpiry ← now + claimDuration, and
  status ← “Closing”.
RegisterPromise(P):
  (a) Require status ∈ {“Active”, “Closing”};
  (b) Require caller. vk ∈ {hub. addr, client. addr};
  (c) Require [P.addr, P.receiver] ∉ unresolvedPromises;
  (d) If P.sender = hub. addr, set sender ← hub and receiver ← client; Otherwise
  set sender ← hub and receiver ← client;
  (e) Require
  SigVerify(P. σ, [cid, P. rid, P. sender, P. receiver, P. addr], sender. addr);
  (f) If caller. vk = receiver. addr and P. rid < receiver. rid, Require
  ACC. VerifyProof(acc, P. addr, P. proof);
  (g) Invoke Deploy (P. byteCode, P. salt);
  (h) Set unresolvedPromises. push([P. addr, receiver])
  (i) If status = “Active”, then set chanExpiry ← now + claimDuration, and
  status ← “Closing”.
Close( ):
  (a) Require status ∈ {“Active”, “Closing”};
  (b) Require caller. vk ∈ {hub. addr, client. addr};
  (c) If caller. vk = hub. addr, set hub. closed ← T; Otherwise set client. closed ←
  T;
  (d) If hub. closed and client. closed, set status ← “Closed”;
  (e) If status = “Active”, then set chanExpiry ← now + claimDuration, and
  status ← “Closing”.
Withdraw( ):
  (a) Require status ∈ {“Closing”, “Closed”};
  (b) If status = “Closing”, Require now < chanExpiry;
  (c) For each (addr, receiver) ∈ unresolvedPromises: receiver. credit ←
  receiver. credit + addr. resolve( ) ;
  (d) Require (hub. deposit + client. deposit) ≥ (hub. credit + client. credit);
  (e) Invoke transfer(hub. addr, hub. deposit + hub. credit − client. credit) and
  transfer(client. addr, client. deposit + client. credit − hub. credit).
```

Table 1 shows a channel contract (as exemplified by pseudocode) according to embodiments. The channel contract may comprise a number of functions including, but not limited to, an initialization function, a get parameters function, a deposit function, a register receipt function, a register promise function, a close function, and a withdraw function. The channel contract may be used to implement an interaction channel. The channel contract may be stored on a blockchain, a hub computer, and/or service provider computers.

An exemplary initialize function is shown Table 1. The initialize function may deploy and initiate the channel contract to a blockchain network. The initialization function, Init (cid′, vk_{H}′, vk_{C}′, claimDuration′), may be a function with four inputs which acts as the contract's constructor. The initialization function defines and initializes the variables used throughout the channel contract. A first variable, cid, may be a channel identifier that identifies the interaction channel. A second variable, claimDuration, may identify the maximum duration that the devices have to submit any claims and is when the channel closes. The first and second variables may be passed to the UPC contract during the contract's deployment phase. The verification keys of the two devices initializing the interaction channel are also provided to the channel contract for initialization.

The get parameters function, GetParams( ), may be a function that is used to retrieve the channel parameters given at the initialization step of the contract. The get parameters function may be used by a device to verify that the channel contract was correctly deployed by the other device.

The deposit function, Deposit (amount), may be a function that is used by a device to increase their on-chain deposit balance, and can be invoked any number of times as long as the contract's status is “Active”.

The register receipt function, RegisterReceipt(R), may be a function used by a device when they decide to close the channel. The register receipt function can be invoked by submitting the last receipt they received from the other device. The input to the register receipt function is a receipt object, R, detailed in Table 2. The register receipt function performs a series of verification checks before updating the on-chain credit values. The first check may ensure that the interaction channel is not in a “Closed” status. Next, the channel contract may ensure that the device invoking the function is a channel participant (e.g., the invoker has an address equal to either the hub.addr, or the client.addr). In the next step, depending on the identity of the invoker of the function, the signature of the receipt object is verified and the appropriate on-chain receipt index (e.g., hub.rid or client.rid), credit (e.g., hub.credit or client.credit), and accumulator (e.g., hub.acc or client.acc) variables are set. For example, if the hub computer invokes the function, the client's address, client.addr, will be used to verify the signature and variables hub.rid, hub.credit, and hub.acc will be updated according to the receipt's values. In a final step, if the interaction channel's status is “Active” (e.g., this call is the initial call for closing of the channel contract), the status is changed to “Closing” and the channel expiry time is set by adding the claimDuration to the current timestamp.

The register promise function, RegisterPromise(P), may be a function used to register a promise(s) for which the channel contract deploys the promise, and later, at the time of withdrawal resolves the amount of the promise. The input to the register promise function is a promise object, P, detailed in Table 2. Similar to the register receipt function, a series of verification checks are performed by the register promise function before updating the on-chain credit values. Similar to the prior function, the first two checks are for ensuring that the status of the channel contract is not “Closed” and the invoking device is a channel participant. Next, to prevent the double spending of funds, the register promise function ensures that the promise, P, has not been registered before by checking the list of unresolvedPromises. In a next step, the signature of the promise, P, is verified.

After the signature is verified, another double spending check is performed by ensuring that the promise is inside the pending promise accumulators, by checking (e.g., membership proof) that the rid is smaller than the one recorded at the RegisterReceipt (e.g., the promise was created before the submitted receipt). Upon validating the promise, the channel contract deploys the promise contract using the promise's bytecode and salt. It further may keep a log of the promise by adding it to the unresolvedPromises list. Finally, similar to the register receipt function, the channel contract's status and chanExpiry variables are set.

The close function, Close( ), may be used in two distinct ways. In a first case, the device calling the close function does not have a receipt or promise and wants to close the channel without claiming any off-chain credits. The second case is for situations that the devices would like to close the channel cooperatively without waiting for the chanExpiry time to arrive. In this scenario, the devices first claim their receipt and promises, then invoke the close function. The close function may first ensure that the invoking device is a channel participant. Next, depending on which device is calling the function, the closed variable of that device will be set to “True”. If both devices (e.g., both the hub and the client) have their closed variables set to “True”, then the status of the channel is changed to “Closed”. Finally, similarly to the previous two functions, the contract's status and chanExpiry variables are set accordingly.

The withdraw function, Withdraw( ), may be a function used by the devices to withdraw their funds once the interaction channel has been successfully closed. First, the function ensures that the interaction channel has been closed by checking the status. If the status is “Closing” then an extra validation of the timestamp against the channel's expiry time (chanExpiry) is performed. Next, the channel contract iterates through the list of unresolvedPromises and invokes the resolve function for each of the promise contracts. The return amount of the call of the withdraw function will be added to the credit of the receiver of that promise. Finally, the function transfers funds according to the deposit and credit amounts for each channel participant.

TABLE 2
Details of variables
Contract Variables

| | |
|---|---|
| chanId | channel identifier |
| status | channel's status (“Active”, “Closing”, “Closed”) |
| hub | hub object (address, on-chain deposit and credit) |
| client | client object (address, on-chain deposit and credit) |
| claimDuration | duration to submit claims before channel termination |
| chanExpiry | channel's expiry time, to be set at the time of channel closing |
| unresolvedPromises | a list of unresolved promises |

Promise (P)

| | |
|---|---|
| type | the application type of the promise |
| rid | index of the latest receipt |
| amount | maximum amount that can be retrieved from the promise |
| sender | sending party of the promise (client or hub) |
| receiver | receiving party of the promise (hub or client) |
| byteCode | bytecode of the promise contract |
| salt | salt to make the promise unique when same bytecode is used |
| addr | address of promise contract based on bytecode and salt |
| proof | membership proof of this promise in an accumulator |

Receipt (R)

| | |
|---|---|
| idx | index of the receipt |
| credit | aggregated promises' amounts resolved off-chain |
| acc | accumulator for tracking pending promises |

Channel (C)

| | |
|---|---|
| cid | channel identifier |
| ledger | ledger that the channel resides on. |
| contract | contract object from the contract deployment |
| cParams | parameters initialized at contract deployment |
| receipt | latest receipt received from the counter party |
| ridᵢₙ & ridₒᵤₜ | the latest index for the (in)outgoing receipts |
| creditᵢₙ & creditₒᵤₜ | (in)outgoing credits respectively |
| Promisesᵢₙ & | (in)outgoing promises respectively |
| Promisesₒᵤₜ | |
| accᵢₙ & accₒᵤₜ | accumulator for (in)outgoing pending promises (Note that each |
| | party of the payment channel (e.g., the client and the hub) can |
| | have a set of outgoing promises (those that it has sent) and a |
| | set of incoming promises (those that it received from the other |
| | party). Each of these accumulators are corresponding to these |
| | sets. Note that the outgoing set of one party is the incoming set |
| | of the other party) |
| accAuxᵢₙ & | auxiliary info used by (in)outgoing accumulators (Note that the |
| accAuxₒᵤₜ | auxiliary information can be used to perform insertions and |
| | deletions to the accumulator. For example, in the case of a |
| | Merkle Tree, each party will keep the list of the promises as the |
| | auxiliary information and the accumulator itself will be the root |
| | of the tree that holds all the info inside the auxiliary set. ) |
| netPromᵢₙ & | aggregate of (in)outgoing pending promise amounts |
| netPromₒᵤₜ | |
| receiptRegistered | check whether receipt has been registered |

FIG. 6 shows a flow diagram illustrating a promise creation method according to embodiments. The method illustrated in FIG. 6 will be described in the context of the first service provider computer 104 initiating a promise method that results in the first service provider computer 104 creating a first promise to the hub computer 112 and the hub computer 112 creating a second promise to the second service provider computer 114.

For example, the method illustrated in FIG. 6 may occur when the first service provider computer 104 attempts to perform a transaction with the second service provider computer 114 (e.g., provide a payment amount to the second service provider computer 114) using the already established channels with the hub computer 112 (e.g., previously established as described in reference to FIG. 5).

The first service provider computer 104 and the second service provider computer 114 can agree on the values for an amount, a hash value, and an expiry time with which the second service provider computer 114 is to later reveal a secret where the hash of the secret (e.g., Hash (secret)) is equal to the hash value. The amount can be a value that is to be provided from one party to the other party. The expiry time can indicate when the interaction is set to expire (e.g., become void). The hash value can be obtained by hashing a secret known by the second service provider computer 114. The second service provider computer 114 can generate the hash value by inputting the secret into a hash function. The secret can be a value known by the second service provider computer 114 but not the hub computer 112 or the first service provider computer 104. The secret can act as a key that opens the hash time-lock contract. As an example, the secret can be a random value generated and stored by the second service provider computer 114 that is difficult for the first service provider computer 104 or the hub computer 112 to guess.

For example, the second service provider computer 114 can generate the secret to be a value, such as 1234567890000. The hashed value can be, for example, Hash (1234567890000)=15618913148.

A first interaction channel between the first service provider computer 104 and the hub computer 112 can be identified with a first channel identifier (e.g., cidA). A second interaction channel between the second service provider computer 114 and the hub computer 112 can be identified with a second channel identifier (e.g., cidB). The hub computer 112 can store both the first channel identifier and the second channel identifier.

Further, a promise contract can be known and accessible by the first service provider computer 104, the hub computer 112, and the second service provider computer 114. The promise contract can include functionality for revealing a secret and resolving the interaction. The promise contract can include additional data and functionality to perform different types of interactions. The promise contract can include computer code (e.g., bytecode) that, when executed by the hub computer 112, performs methods relating to the type of interaction being performed. The promise contract can be identified by a promise type created in a promise by the first service provider computer 104 along with the promise contract.

As examples, the promise contract can be an HTLC smart contract, a smart contract that allows fractional payments, a smart contract that allows for cancelation, a smart contract that allows for matching payments with resource usage, a smart contract that allows for quality checks prior to finalization, a smart contract that allows for call/put options, a smart contract that allows for auctions, and any other type of smart contract that includes executable computer code.

Table 3, below, includes an example of a promise contract that is a HTLC smart contract. The HTLC smart contract can be a smart contract that can be utilized to reveal and resolve the secret for the interaction. The HTLC smart contract can be initialized with the amount, the hash value, and the expiry time.

The HTLC contract can be invoked to reveal the secret and to resolve the interaction. For example, the second service provider computer 114 can call the HTLC contract's reveal secret method by providing the secret to the HTLC contract. The HTLC contract can determine if the HTLC contract is expired using the expiry time. The HTLC contract can verify the hash the received secret to obtain a derived hash value, which can be compared to the hash value. If the derived hash value matches the hash value, then the HTLC contract can determine that the secret has been successfully revealed.

The HTLC contract can also allow the second service provider computer 114 to resolve the interaction via a resolve function. The HTLC contract can verify that the secret has been successfully revealed and then return the amount to the second service provider computer 114.

As an example, the HTLC contract may supplement the channel contract for HTLC type promises. The HTLC contract code (e.g., bytecode included in the promise) may be used by all parties to create and verify HTLC promises. For promise registration, the channel contract will deploy the HTLC contract for each of the HTLC promises (e.g., execute the promise contract's bytecode). The HTLC contract can include an initialization function, a reveal secret function, and a resolve function.

The initialization function, Init(amount′, hash′, expiry′), may be a function which acts a constructor of the contract and initializes the contract variables. The values amount, hash, and expiry are given as input to the UPC contract.

The reveal secret function, RevealSecret(secret), may be a function which takes a secret value as input and checks two conditions. First, the reveal secret function checks that the current time is not beyond the expiry time of the contract. Second, the reveal secret function ensures that the cryptographic hash of the secret matches the hash value of the contract (e.g., the secret is the pre-image of the hash). If both of the verifications pass, then the contract's secretRevealed variable will be set to True.

The resolve function, Resolve( ), may be a function that is called by the channel contract at the time of withdrawal to determine the amount of the promise that needs to be credited to the receiver. In the case that the secret was revealed successfully (e.g., secretRevealed is “True”), the full amount of the promise is returned to the channel contract. Otherwise, if the current time is less than the expiry value, an exception will be provided, indicating that there is still time for revealing the secret. If no secret is revealed and the expiry time has passed, a zero amount will be sent to the channel contract.

TABLE 3
Example HTLC contract as a promise contract

```
Init(amount′,hash′,expiry′):
  (a) Set (amount,hash,expiry) ← (amount′,hash′,expiry′);
  (b) Set secretRevealed ← F.
RevealSecret(secret):
  (a) Require now < expiry;
  (b) Require Hash(secret) = hash;
  (c) Set secretRevealed ← T;
Resolve( ):
  (a) If secretRevealed, then return amount;
  (b) Require now ≥ expiry;
  (c) Return 0.
```

The promise creation method can also be performed between the first service provider computer 104 that is operating on behalf of a user and the second service provider computer 114 that is operating on behalf of a hotel booking system. The user can attempt to book a particular room in a hotel offered by the hotel booking system. The first service provider computer 104 and the second service provider computer 114 can determine an amount for the hotel room (e.g., based on an amount charged by the hotel booking system) that is $500, a hash value that is 123456789, and an expiry time that is Feb. 1, 2023 (e.g., which may be a reservation date). The first service provider computer 104 and the second service provider computer 114 can decide to use a promise contract that includes computer code that, when executed, provides functionality for cancelling the hotel room booking under certain conditions (e.g., a cancellation smart contract). The cancellation smart contract can include computer code that includes conditions where the first service provider computer 104 can cancel the reservation prior to Jan. 15, 2023 and receive a full refund (e.g., cancel the promise). The cancellation smart contract can further include computer code that includes conditions where the first service provider computer 104 can cancel the reservation between Jan. 15, 2023 and Feb. 1, 2023, but may only receive a partial refund (e.g., the user provides $250 to the hotel booking system).

Prior to step 602, the first service provider computer 104 and the hub computer 112 can verify that the first interaction channel is active as indicated in the first channel contract (e.g., a UPC contract as described in reference to FIG. 5) corresponding to the first interaction channel. The second service provider computer 114 and the hub computer 112 can verify that the second interaction channel is active as indicated in the second channel contract corresponding to the second interaction channel. If any computer determines that an interaction channel is not active, then that computer can terminate the interaction process.

At step 602, the first service provider computer 104 can create a first promise. The first promise can be a promise to provide an amount to the second service provider computer 114 via the hub computer 112 upon completion of the interaction according to rules indicated by executable computer code in the selected promise contract. The first service provider computer 104 can create the first promise based on the first channel contract as identified by the first contract identifier, a promise type, the promise contract, a plurality of parameters, a first service provider verification key, a first service provider secret key, and a hub computer verification key (e.g., P_{A}←CreatePromise(C_{A}[cid_{A}],promiseType,interactionTypeContract,params,vk_{A},vk_{H},sk_{A})). The first service provider computer 104 can set the plurality of parameters to include the amount, the hash value, and the expiry time added with an elapsed time from the first interaction channel's contract.

The first service provider computer 104 can generate the first promise including a first channel identifier, a first latest receipt index (e.g., which may be null if no previous promises and receipts have taken place), a first salt, first computer code, a first promise address, a first digital signature, the first service provider verification key, and the hub computer verification key. To generate the first promise, the first service provider computer 104 can perform the following steps. The first service provider computer 104 can set the first channel identifier of the promise to be equal to the first channel identifier that identifies the first interaction channel. The first service provider computer 104 can set the first latest receipt index equal to the latest outgoing receipt index of the first channel contract. The first service provider computer 104 can set the first salt to a random value or predetermined pseudorandom value. The first service provider computer 104 can set the first computer code of the first promise equal to a concatenation of the promise contract's computer code and the plurality of parameters. The service provider computer 104 can generate the first digital signature on the first contract identifier, first the latest receipt index, the first service provider computer verification key, the hub computer verification key, and the first promise address using a first service provider computer private key that corresponds to the first service provider computer verification key. The first service provider computer 104 can include the first digital signature into the first promise along with the aforementioned data.

After generating the first promise, the first service provider computer 104 can add the first promise to a list of outgoing promises included in the first channel contract. The first service provider computer 104 can also add the first promise to the outgoing accumulator included in the first channel contract. The outgoing accumulator can accumulate promises that are to be processed and completed. The accumulator can provide proofs that a particular promise is included in the accumulator.

As an illustrative example, the first service provider computer 104 can generate the promise to provide the $500 to the second service provider computer 114 for booking the agreed upon hotel room conditionally upon execution of the computer code in the promise contract with cancellation conditions. The first service provider computer 104 can generate the promise comprising the first channel identifier (e.g., 0001), the first latest receipt index (e.g., null), a first salt (e.g., 54321), the first computer code (e.g., the promise contract's computer code concatenated with the plurality of parameters), the first promise address (e.g., an address created from the computer code and the salt), the first digital signature (e.g., created using the first service provider private key), the first service provider verification key, and the hub computer verification key.

At step 604, after generating the first promise, the first service provider computer 104 can generate a sender message comprising the first promise. The first service provider computer 104 provide the sender message to the hub computer 112. The sender message can also include an indication of the recipient of the amount. For example, the sender message can include data that identifies the second service provider computer 114 (e.g., a second service provider computer verification key, a second service provider computer identifier, etc.).

At step 606, after receiving the sender message including the first promise from the first service provider computer 104, the hub computer 112 can evaluate the first promise. Evaluating the first promise can include verifying an expiry time of the first promise, verifying a promise type of the first promise, and/or verifying additional data included in the first promise.

The hub computer 112 can verify that the claim expiry time indicated in the plurality of parameters included in the first promise is not greater than (e.g., after) the expiry of the first interaction channel between the first service provider computer 104 and the hub computer 112. If the claim expiry time is greater than the expiry of the first interaction channel, the hub computer 112 can abort the interaction process and can notify the first service provider computer 104 of the abortion reason.

Prior to, or after, verifying the claim expiry time, the hub computer 112 can verify that the first promise type is a promise type that the hub computer 112 is capable of performing. For example, the hub computer 112 can process promise types that indicate particular promise contracts (e.g., HTLC, cancellation, etc.). The hub computer 112 can verify that the promise type corresponds to a valid promise contract that the hub computer 112 can process. The hub computer 112 can store a lookup table of promise types that the hub computer 112 can process. The hub computer 112 can search the lookup table for the promise type. If the promise type is not in the lookup table, then the hub computer 112 can deny the promise and end the process. If the promise type is included in the lookup table, then the hub computer 112 can continue with the process.

At step 608, after verifying the expiry times, the hub computer 112 can verify the first promise. The hub computer 112 can verify the first promise using data included in the first promise. The hub computer 112 can verify the first promise using the first channel identifier, the promise contract, the plurality of parameters, the first service provider computer verification key, and the hub computer verification key (e.g., VerifyPromise(C_{H}[cid_{A}],P_{A},htlcContract,P_{A},params,vk_{A},vk_{H},vk_{A})).

When verifying the first promise, the hub computer 112 can verify that the first service provider computer 104 has sufficient funds to perform the first promise. The hub computer 112 can evaluate the first channel contract to determine if the first service provider computer 104 has sufficient funds. In particular, the hub computer 112 can determine if a total fund value equal to a sum of a deposit value and a credit out value is greater than a total owed value equal to a sum of a credit in value, a net promise in value, and the amount in the first promise (e.g., C.creditᵢₙ+C.netPromᵢₙ+P.amount<deposit+C.creditₒᵤₜ). The deposit value can be an amount of funds deposited by the first service provider computer 104 with the hub computer 112. The credit out value can be an amount of funds owed by the hub computer 112 to the first service provider computer 104. The credit in value can be an amount of funds owed by the first service provider computer 104 to the hub computer 112. The net promise in value can be an amount of funds promised by the first service provider computer 104 to the hub computer 112. The credit out value, the credit in value, and the net promise in value can be included in the first channel contract.

When verifying the first promise, the hub computer 112 can verify the digital signature. The hub computer 112 can verify the digital signature using the first service provider computer verification key that corresponds to the first service provider computer private key (an example of a first computer private key) used to form the digital signature.

After verifying the first promise, the hub computer 112 can add the first promise to a list of ingoing promises in the first channel contract. The hub computer 112 can update the net promise in value in the first channel contract to be equal to the net promise in value added with the amount included in the first promise.

The hub computer 112 can add the first promise to the ingoing accumulator included in the second channel contract. The ingoing accumulator can accumulate promises that are to be processed and completed. The accumulator can provide proofs that a particular promise is included in the accumulator.

At step 610, after verifying the first promise, the hub computer 112 can execute the computer code (e.g., bytecode) included in the first promise. The hub computer 112 can execute the computer code to initiate the performance of the transaction. The computer code can be code included in the promise contract. In some embodiments, the hub computer 112 can deploy the computer code in the promise contract to the blockchain. The computer code can perform functionality that effects the outcome of the interaction. For example, the computer code can include conditional rules that influence the interaction by altering how funds are provided, when funds are provided, if funding can be reversed, and/or any other type of change to the interaction flow. The computer code, once deployed, can automatically perform functionalities and/or perform functionalities upon request. For example, the computer code of the promise contract can include public function calls that allow devices to call the functions to perform functionality.

As an illustrative example, promise contract can be a reservation cancellation contract that allows a user to create a reservation and to conditionally cancel the reservation. The promise contract allows the user to cancel the reservation prior to Jan. 15, 2023 and receive a full refund (e.g., cancel the promise). The cancellation smart contract can further include computer code that includes conditions where the first service provider computer 104 can cancel the reservation between Jan. 15, 2023 and Feb. 1, 2023, but may only receive a partial refund (e.g., the user provides $250 to the hotel booking system). These conditions in the computer code can be validated/performed when the interaction channel between the first service provider computer 104 and the hub computer 112 closes. For example, when the interaction channel closes (e.g., as initiated by the user between Jan. 15, 2023 and Feb. 1, 2023), the channel contract iterates through the list of unresolved promises and invokes a resolve function for each of the promise contracts. The promise contract can determine that the current date is between Jan. 15, 2023 and Feb. 1, 2023. The promise contract can return a fulfilled amount to the channel contract of $250 due to the cancellation occurring during the partial refund period.

At step 612, after executing the computer code of the first promise, the hub computer 112 can generate a second promise. Note that the execution of the computer code can be ongoing, even during the generation of the second promise. The hub computer 112 can generate the second promise in a similar manner to how the first service provider computer 104 generates the first promise. The hub computer 112 can generate the second promise using the second channel contract as identified by the second channel identifier, a second promise type, the promise contract, the plurality of parameters included in the first promise, the hub computer verification key, the hub computer private key, and the second service provider computer verification key (e.g., P_{H}←CreatePromise(C_{H}[cid_{B}],promiseType,promiseContract,P_{A},params,vk_{H},vk_{B},sk_{H}))

The hub computer 112 can generate the second promise including a second channel identifier, a second latest receipt index, a second salt, second computer code (e.g., second bytecode), a second promise address, a second digital signature, the second service provider verification key, and the hub computer verification key. To generate the second promise, the hub computer 112 can perform the following steps. The hub computer 112 can set the second channel identifier of the second promise to be equal to the second contract identifier that identifies the second interaction channel. The hub computer 112 can set the second latest receipt index equal to a latest outgoing receipt index of the second channel contract. The hub computer 112 can set the second salt to a random value or predetermined pseudorandom value. The hub computer 112 can set the second computer code of the second promise equal to a concatenation of the promise contract's computer code and the plurality of parameters. The hub computer 112 can generate a second digital signature on the second contract identifier, the second latest receipt index, the second service provider computer verification key, the hub computer verification key, and the second promise address using a hub computer private key that corresponds to the hub computer verification key. The hub computer 112 can include the second digital signature into the second promise along with the aforementioned data.

After generating the second promise, the hub computer 112 can add the second promise to a list of outgoing promises included in the second channel contract. The hub computer 112 can also add the second promise to an outgoing accumulator included in the second interaction channel.

After generating the second promise, the hub computer 112 can create a promise mapping between the first promise and the second promise. The promise mapping can associate the two promises with one another to indicate that they are related. The hub computer 112 can use the promise mapping as a lookup table to switch between the first interaction channel and the second interaction channel.

As an illustrative example, the hub computer 112 can generate the second promise to provide the $500 to the second service provider computer 114 for booking the agreed upon hotel room conditionally upon execution of the computer code in the promise contract with cancellation conditions. The hub computer 112 can generate the second promise comprising the second channel identifier (e.g., 0002), the second latest receipt index (e.g., null), a second salt (e.g., 41253), the second computer code (e.g., the promise contract's computer code concatenated with the plurality of parameters), the second promise address (e.g., an address created from the computer code and the salt), the second digital signature (e.g., created using the hub computer private key), the second service provider verification key, and the hub computer verification key.

At step 614, after generating the second promise, the hub computer 112 can provide the second promise to the second service provider computer 114.

At step 616, after receiving the second promise from the hub computer 112, the second service provider computer 114 can verify that the claim expiry time indicated in the plurality of parameters included in the second promise is not greater than (e.g., after) the expiry of the second interaction channel between the second service provider computer 114 and the hub computer 112. If the claim expiry time is greater than the expiry of the second interaction channel, the second service provider computer 114 can abort the interaction process and can notify the hub computer 112 of the abortion reason.

Prior to, or after, verifying the claim expiry time, the second service provider computer 114 can verify that the second promise type is a promise type that the second service provider computer 114 is capable of performing.

After verifying the expiry times, the second service provider computer 114 can verify the second promise. The second service provider computer 114 can verify the second promise using data included in the second promise. The second service provider computer 114 can verify the second promise using the second channel identifier, the promise contract, the plurality of parameters, the second service provider computer verification key, and the hub computer verification key (e.g., VerifyPromise(C_{B}[cid_{H}],P_{A},promiseContract,P_{H}.params,vk_{H},vk_{B},vk_{H})).

When verifying the second promise, the second service provider computer 114 can verify that the hub computer 112 has sufficient funds to perform the second promise. The second service provider computer 114 can evaluate the second channel contract to determine if the hub computer 112 has sufficient funds. In particular, the second service provider computer 114 can determine a total expenses value for the hub computer 112 that includes an ingoing credit value (e.g., funds owed by the hub computer 112 to the second service provider computer 114), a net promise value (e.g., funds promised by the hub computer 112 to the second service provider computer 114), and the amount of the second promise. The second service provider computer 114 can also determine a total funds value for the hub computer 112 that includes a hub computer deposit value and an outgoing credit value (e.g., funds owed by the second service provider computer 114 to the hub computer 112). The second service provider computer 114 can determine whether or not the total expenses value is less than the total funds value. For example, the second service provider computer 114 can determine C.creditᵢₙ+C.netPromᵢₙ+P.amount<deposit+C.creditₒᵤₜ).

When verifying the second promise, the second service provider computer 114 can verify the second digital signature. The second service provider computer 114 can verify the second digital signature using the hub computer verification key that corresponds to the hub computer private key used to form the second digital signature.

After verifying the second promise, the second service provider computer 114 can add the second promise to a list of promises in the second channel contract. The second service provider computer 114 can update net promise value (e.g., value promised by the hub computer 112 to the second service provider computer 114) with the amount of the second promise. The second service provider computer 114 can add the second promise to the ingoing accumulator.

At step 618, after verifying the second promise, the second service provider computer 114 can execute the computer code included in the second promise. The second service provider computer 114 can execute the computer code to initiate the performance of the transaction. The computer code can be code included in the promise contract. In some embodiments, the second service provider computer 114 can deploy the computer code in the promise contract to the blockchain. The computer code can perform functionality that effects the outcome of the interaction. For example, the computer code can include conditional rules that influence the interaction by altering how funds are provided, when funds are provided, if funding can be reversed, and/or any other type of change to the interaction flow. The computer code, once deployed, can automatically perform functionalities and/or perform functionalities upon request. For example, the computer code of the promise contract can include public function calls that allow devices to call the functions to perform functionality.

After step 618, the creation of the promises can result in the first service provider computer 104 promising to provide the amount to the hub computer 112, which in turn has promised to provide the amount to the second service provider computer 114.

FIG. 7 shows a flow diagram illustrating an interaction completion method according to embodiments. The method illustrated in FIG. 7 will be described in the context of the second service provider computer 114 generating a secret to claim the second promise's amount (e.g., obtain a receipt). The method illustrated in FIG. 7 can illustrate completing the interaction initiated if FIG. 6.

The method illustrated in FIG. 7 can be an example of a receipt generation process during interaction completion, where the promise type is a HTLC promise. The HTLC promise may indicate that the second service provider computer 114 needs to provide a secret in order to complete the interaction to generate receipts.

It is understood, however, that any appropriate steps may occur in place of steps 702-708 depending on the promise type and the computer code included in the promise contract to generate the second receipt. Similarly, any appropriate steps may occur in place of steps 712-716 depending on the promise type and the computer code included in the promise contract to generate the first receipt. For example, a hotel reservation cancellation process, described below, can include different steps that occur prior to providing receipts than steps 702-708 and 712-716.

At step 702, the second service provider computer 114 can obtain the secret that was utilized to determine the hash value for the interaction prior to step 602. The second service provider computer 114 can obtain the secret from memory. For example, the second service provider computer 114 can retrieve the secret of 1234567890000 from memory.

At step 704, after obtaining the secret, the second service provider computer 114 can provide the secret and the second promise to the hub computer 112 to claim the amount in the second promise. In some embodiments, the secret can be included in the second promise.

At step 706, after receiving the secret and the second promise from the second service provider computer 114, the hub computer 112 can evaluate the secret and the second promise. The hub computer 112 can evaluate the secret and the second promise as follows.

The hub computer 112 can determine if the second promise received from the second service provider computer 114 is a valid promise and has not been maliciously altered. For example, the hub computer 112 can determine whether or not the second promise is included in the second interaction channel's contract's list of hub computer outgoing promises. If the second promise, received from the second service provider computer 114, is not included in the second channel contract, then the hub computer 112 cannot complete the claim for the second promise and can stop evaluating the received secret and second promise.

The hub computer 112 can also evaluate the secret to determine if the secret is valid. The hub computer 112 can hash the secret using a hash function to obtain a derived hash value. The hub computer 112 can compare the derived hash value to the hash value included in the plurality of parameters included in the second promise. If the derived hash value matches the hash value, then the secret is valid. If the derived hash value does not match the hash value, then the hub computer 112 cannot complete the claim for the second promise and can stop evaluating the received secret and second promise.

As an example, the hub computer 112 can receive the secret of 1234567890000 from the second service provider computer 114. The hub computer 112 can determine a derived hash value of Hash (1234567890000)=15618913148. The hub computer 112 can then compare the derived hash value of 15618913148 to the hash value included in the plurality of parameters included in the second promise of 15618913148. Since the two values match, the hub computer 112 can proceed with processing the interaction.

The hub computer 112 can also evaluate the second promise to determine whether or not the second promise has expired based on the expiry time included in the plurality of parameters included in the second promise.

At step 708, after evaluating the secret and the second promise, the hub computer 112 can generate a second receipt. The hub computer 112 can generate the second receipt based on the second channel contract, the second promise, the amount of the second promise, and the hub computer private key. For example, the hub computer 112 can generate the second receipt by performing the following steps.

The hub computer 112 can increment the value of the latest receipt index of the second channel contract. For example, the hub computer 112 can increment the latest receipt index by 1.

The hub computer 112 can update the credit out value of the second channel contract. The credit out value can indicate the amount owed by the hub computer 112 to the second service provider computer 114. The hub computer 112 can update the credit out value based on the amount of the second promise. For example, the hub computer 112 can increase the current credit out value by the amount of the second promise. The hub computer 112 also can delete the second promise from the outgoing accumulator included in the second channel contract.

The hub computer 112 can remove the second promise from the list of hub computer outgoing promises in the channel contract. The hub computer 112 can remove the second promise to indicate the second promise is, or is in the process of, being fulfilled.

After removing the second promise from the list of hub computer outgoing promises, the hub computer 112 can obtain the second channel identifier, the latest receipt index, the credit out value, and the second accumulator. The hub computer 112 can form a digital signature on the second channel identifier, the latest receipt index, the credit out value, and the second accumulator using the hub computer private key. The digital signature can indicate proof that the second promise has been completed. The digital signature can be included in the second receipt.

At step 710, after generating the second receipt, the hub computer 112 can provide the second receipt to the second service provider computer 114 to indicate completion of the second promise. At any point hereafter, the hub computer 112 and the second service provider computer 114 can close the second interaction channel and settle the amounts included in the second channel contract. Additionally, after receiving the second receipt, the second service provider computer 114 can verify the second receipt, as described in step 722.

In some embodiments, the hub computer 112 can utilize the previously created promise mapping between the first promise and the second promise to determine which computer to communicate with regarding the first promise. The hub computer 112 can obtain the first promise from the promise mapping using the second promise.

At step 712, after providing the second receipt to the second service provider computer 114, the hub computer 112 can provide the first promise and the secret to the first service provider computer 104. In some embodiments, the secret can be included in the first promise.

At step 714, after receiving the first promise and the secret from the hub computer 112, the first service provider computer 104 can evaluate the secret and the first promise. The first service provider computer 104 can evaluate the secret and the first promise as follows.

The first service provider computer 104 can determine if the first promise received from the hub computer 112 is a valid promise and has not been maliciously altered. For example, the first service provider computer 104 can determine whether or not the first promise is included in the first interaction channel's contract's list of first service provider computer outgoing promises. If the first promise, received from the hub computer 112, is not included in the first channel contract, then the first service provider computer 104 cannot complete the claim for the first promise and can stop evaluating the received secret and first promise.

The first service provider computer 104 can also evaluate the secret to determine if the secret is valid. The first service provider computer 104 can hash the secret using a hash function to obtain a derived hash value. The first service provider computer 104 can compare the derived hash value to the hash value included in the plurality of parameters included in the first promise. If the derived hash value matches the hash value, then the secret is valid. If the derived hash value does not match the hash value, then the first service provider computer 104 cannot complete the claim for the first promise and can stop evaluating the received secret and first promise.

As an example, the first service provider computer 104 can receive the secret of 1234567890000 from the hub computer 112. The first service provider computer 104 can determine a derived hash value of Hash (1234567890000)=15618913148. The first service provider computer 104 can then compare the derived hash value of 15618913148 to the hash value included in the plurality of parameters included in the first promise of 15618913148. Since, the two values match, the first service provider computer 104 can proceed with processing the interaction.

The first service provider computer 104 can also evaluate the first promise to determine whether or not the first promise has expired based on the expiry time included in the plurality of parameters included in the first promise.

At step 716, after evaluating the secret and the first promise, the first service provider computer 104 can generate a first receipt. The first service provider computer 104 can generate the first receipt based on the first channel contract, the first promise, the amount of the first promise, and the first service provider computer private key. For example, the first service provider computer 104 can generate the first receipt by performing the following steps.

The first service provider computer 104 can increment the value of the latest receipt index of the first channel contract. For example, the first service provider computer 104 can increment the latest receipt index by 1.

The first service provider computer 104 can update the credit out value of the first channel contract. The credit out value can indicate the amount owed by the first service provider computer 104 to the hub computer 112. The first service provider computer 104 can update the credit out value based on the amount of the first promise. For example, the first service provider computer 104 can increase the current credit out value by the amount of the first promise. The first service provider computer 104 can also delete the first promise from the outgoing accumulator included in the first channel contract.

The first service provider computer 104 can remove the first promise from the list of first service provider computer outgoing promises in the first channel contract. The first service provider computer 104 can remove the first promise to indicate the first promise is, or is in the process of, being fulfilled.

After removing the first promise from the list of first service provider computer outgoing promises, the first service provider computer 104 can obtain the first channel identifier, the latest receipt index, the credit out value, and the first accumulator. The first service provider computer 104 can form a digital signature on the first channel identifier, the latest receipt index, the credit out value, and the second accumulator using the first service provider computer private key. The digital signature can indicate proof that the first promise has been completed. The digital signature can be included in the first receipt.

At step 718, after generating the first receipt, the first service provider computer 104 can provide the first receipt and the first promise to the hub computer 112.

At step 720, after receiving the first receipt and the first promise from the first service provider computer 104, the hub computer 112 can verify the first receipt. The hub computer 112 can verify the first receipt using the first channel contract, the first receipt, the first promise, and the hub computer verification key. For example, the hub computer 112 can verify the first receipt by performing the following steps.

The hub computer 112 can verify the digital signature included in the first receipt. The hub computer 112 can verify the digital signature using the first service provider computer verification key that corresponds to the first service provider computer private key that was used to form the digital signature. If the digital signature is not valid, then the hub computer 112 can proceed to enforce the first channel contract by pushing the first channel contract to the blockchain network. If the digital signature is valid, then the hub computer 112 can proceed with verifying the first receipt. The hub computer 112 can also delete the first promise from the ingoing accumulator included in the first interaction channel.

After verifying the digital signature, the hub computer 112 can add the first receipt to the first channel contract. The hub computer 112 can then increment the latest receipt index of the first channel contract by 1. The hub computer 112 can also increase the hub computer credit in value by the amount included in the first promise.

The hub computer 112 can remove the first promise from the hub computer list of ingoing promises included in the first channel contract.

At any point after verifying the first receipt, the hub computer 112 in conjunction with the first service provider computer 104 can close the first interaction channel and settle any credit values in the first interaction contract.

At step 722, after receiving the second receipt and the second promise from the hub computer 112, the second service provider computer 114 can verify the second receipt. The second service provider computer 114 can verify the second receipt using the second channel contract, the second receipt, the second promise, and the second service provider computer verification key. For example, the second service provider computer 114 can verify the second receipt by performing the following steps.

The second service provider computer 114 can verify the digital signature included in the second receipt. The second service provider computer 114 can verify the digital signature using the hub computer verification key that corresponds to the hub computer private key that was used to form the digital signature. If the digital signature is not valid, then the second service provider computer 114 can proceed to enforce the second channel contract by pushing the second channel contract to the blockchain network. If the digital signature is valid, then the second service provider computer 114 can proceed with verifying the second receipt. The second service provider computer 114 can delete the second promise from the ingoing accumulator.

After verifying the digital signature, the second service provider computer 114 can add the second receipt to the second channel contract. The second service provider computer 114 can then increment the latest receipt index of the second channel contract by 1. The second service provider computer 114 can also increase the second service provider computer credit in value by the amount included in the second promise.

The second service provider computer 114 can remove the second promise from the second service provider computer list of ingoing promises included in the second channel contract.

At any point after verifying the first receipt, the hub computer 112 in conjunction with the second service provider computer 114 can close the second interaction channel and settle any credit values in the second interaction contract.

When the interaction channel is closed, the channel contract iterates through the list of unresolved promises, if any, and invokes a resolve function for each of the promise contracts in the computer code. The computer code can include any programmed conditions that dictate the amount to be provided from the unresolved promise based on current conditions (e.g., current time, etc.).

As an illustrative example, referring back to the hotel reservation example, the conditions in the bytecode can be validated/performed when both the first interaction channel and the second interaction channel close. As an example, the first service provider computer 104 can initiate the closing of the first interaction channel on Jan. 20, 2023 (e.g., because a first user associated with the first service provider computer 104 wishes to cancel their hotel reservation). In response, the hub computer 112 can determine the second interaction channel that is associated with the first interaction channel using the promise mapping to initiate the closing of the second interaction channel. Each channel contract can execute the promise contract bytecode for each unresolved promise (e.g., including the first promise and the second promise). In this case, there can be two unresolved promises. The first unresolved promise would be for the first service provider computer 104 to pay the hub computer $500, while the second unresolved promise would be for the hub computer 112 to pay the second service provider computer 114 $500.

The first channel contract and the second channel contract can then execute the bytecode. Each instance of the bytecode can determine that the current date is Jan. 20, 2023, which lies within the partial refund period ranging from Jan. 15, 2023 to Feb. 1, 2023. Each instance of the bytecode can determine that the unresolved promise should be resolved using the amount of $250 (which is the partial amount compared to the total of $500) for each of the unresolved promises. As such, the first promise is resolved by the first contract channel by having the first service provider computer 104 provide $250 to the hub computer 112 (e.g., via a deposit or a credit). The second promise is resolved by the second contract channel by having the hub computer 112 provide $250 to the second service provider computer 114 (e.g., via a deposit or a credit). The bytecode can contain logic to perform the messaging to accomplish the above-noted functions.

Table 4 shows example functions that perform functionalities for the methods described in reference to FIG. 6 and FIG. 7.

TABLE 4
Off-Chain Helper Functions

```
CreatePromise(C,type,contract,params,amount,sender,receiver,sk):
  cid ← C.cid; rid ← C.ridₒᵤₜ; salt (e.g.,a random number from a large set);
  byteCode ← contract.byteCode||params;
  addr ← getPromiseAddress(byteCode,salt).
  (a) P ← [type,rid,amount,sender,receiver,byteCode,salt,addr,σ],
  where σ ← Sign([cid,rid,sender,receiver,addr],sk);
  (b) Add P to C.Promisesₒᵤₜ;
  (c) ACC.Insert(C.accₒᵤₜ,addr,C.accAuxₒᵤₜ);
  (d) Output P.
VerifyPromise(C,P,contract,params,sender,receiver,vk):
  cid ← C.cid; rid ← C.ridᵢₙ; salt ←??;
  byteCode ← contract.byteCode||params;
  addr ← getPromiseAddress(byteCode,salt).
  (a) Output False if any of the following conditions is true:
    C.creditᵢₙ + C.netPromᵢₙ + P.amount > deposit + C.creditₒᵤₜ;
    SigVerify(P.σ, [cid,rid,sender,receiver,addr],vk) = 0;
  (b) Add P to C.Promisesᵢₙ and set C.netPromᵢₙ ← C.netPromᵢₙ + P.amount;
  (c) ACC.Insert(C.accᵢₙ,addr,C.accAuxᵢₙ);
  (d) Output True.
CreateReceipt(C,P,amount,sk):
  (a) Set C.ridₒᵤₜ ← C.ridₒᵤₜ + 1;
  (b) Set C.creditₒᵤₜ < C.creditₒᵤₜ + amount;
  (c) ACC.Delete(C.accₒᵤₜ,P.addr,C.accAuxₒᵤₜ);
  (d) Remove P from C.Promisesₒᵤₜ;
  (e) (cid,rid,credit,acc) ← (C.cid,C.ridₒᵤₜ,C.creditₒᵤₜ,C.accₒᵤₜ);
  (f) Output R ← [rid,credit,acc,σ], where σ ← Sign([cid,rid,credit,acc],sk);
VerifyReceipt(C,R,P,amount,vk):
  cid ← C.cid; rid ← C.ridᵢₙ + 1; credit ← C.creditᵢₙ + amount;
  acc ← C.accᵢₙ; accAux ← C.accAuxᵢₙ;
  (a) ACC.Delete(acc,P.addr,accAux);
  (b) If SigVerify(R.σ, [cid,rid,credit,acc],vk) = 0 output False;
  (c) Set C.receipt ← R;
  (d) Set C.ridᵢₙ ← C.ridᵢₙ + 1;
  (e) Set C.creditᵢₙ ← C.creditᵢₙ + amount;
  (f) ACC.Delete(C.accᵢₙ,P.addr,C.accAuxᵢₙ);
  (g) Remove P from C.Promisesᵢₙ;
  (h) Output True;
```

As per the promise functions included in Table 4. The create promise function, CreatePromise(C, type, contract.params, amount, sender, receiver, sk), may be a function used to create a promise given the following inputs: promise type, the promise contract, which includes contract code to be deployed when the promise is registered, a plurality of parameters (e.g., which can indicate the parameters of the promise needed at the time of the promise deployment), an amount, a sender address, and receiver address. The promise bytecode is derived by concatenating the promise contract's bytecode with the initial inputs to the contract which are given by the plurality of parameters variable from the input. Furthermore, the address of the promise contract is derived by using the promise's bytecode and salt. Next, the promise object is created along with a signature on the promise variables by the calling device. Additionally, the created promise is added to a list of outgoing promises of the calling device and the address of the promise is added to the outgoing accumulator account. The outgoing accumulator can be used to cryptographically keep track of promises and can be used to prove that a particular promise was created.

A verify promise function, VerifyPromise (C, P, contract, params, sender, receiver, vk), may be a function that is paired with the create promise function, which verifies a promise. Similar to the create promise function, the bytecode and the address of the promise is derived from the input values. The verify promise function can check that the counter-party has sufficient funds to cover for the amount of the promise. The verify promise function can also verify the signature of the counter-party on the promise variables. After the two verifications, the promise is added to the a list of ingoing promises and the promise's address is inserted into the ingoing accumulator (accᵢₙ). Further, the aggregated ingoing pending promise amount (netPromᵢₙ) is updated such that the next promise amounts do not exceed the collateral and credits that the counter-party holds.

Table 5 shows an example off-chain interaction protocol that includes pseudocode illustrating the methods described in reference to FIG. 6 and FIG. 7.

TABLE 5
Off-chain interaction protocol

```
Preliminaries
  - Let device A attempt to make a transaction to device B using the already
  established channels with hub H. Both A and B agree on the values txAmount,
  txHash, and txExpiry for which B to reveal secret where Hash(secret) =
  txHash.
  - Let cid_{A} denote the channel id that A will use for this payment. Likewise, let
  cid_{B} denote the channel id for B. The Hub knows cid_{A}, cid_{B}.
  - Let htlcContract denote the contract in Table 3 known by all parties. In this
  example, the promise contract can be an HTLC contract.
  - Before beginning each off-chain protocol, the devices check the
  corresponding channel's status on the contract and abort if it is not “Active.”
Authorize Protocol
  (a) A begins by performing the following steps:
    i. Set params ← (txAmount,txHash,txExpiry + C_{A}.ledger.Δ);
    ii. P_{A} ←
    CreatePromise(C_{A}[cid_{A}],″HTLC″,htlcContract,params,vk_{A},vk_{H},sk_{A});
    iii. Send [SenderPromise,P_{A}A,B] to H.
  (b) Upon receiving [SenderPromise,P_{A},B] from A and P_{A}.type = ″HTLC″, H
  does the following:
    i. Abort if P_{A}.params.expiry − now > C.cParams.claimDuration;
    ii. Abort if
    VerifyPromise(C_{H}[cid_{A}],P_{A},htlcContract,P_{A}.params,vk_{A},vk_{H},vk_{A}) =
    False;
    iii. Set P_{A}.params.txExpiry ← P_{A}.params.txExpiry − C_{A}.ledger.Δ;
    iv. P_{H} ←
    CreatePromise(C_{H}[cid_{B}],″HTLC″,htlcContract,P_{A}.params,vk_{H},vk_{B},sk_{H});
    v. PromiseMapping[P_{H}.hash] ← (A,cid_{A},P_{A},B,cid_{B},P_{H});
    vi. Send [HubPromise,P_{H}] to B.
  (c) Upon receiving [HubPromise, P H] from H and P H.type = ″HTLC″,
  client B does the following: [leftmargin=*]
    i. Abort if (txAmount,txHash,txExpiry) ≠ P_{H}.params;
    ii. Abort if
    VerifyPromise(C_{B}[cid_{H}],P_{H},htlcContract, P_{H}.params,vk_{H},vk_{H},vk_{H}) =
    False;
Payment Protocol
  (a) Client B begins by sending [HTLCSecret,P_{H},secret] to H.
  (b) Upon receiving [HTLCSecret,P_{H},secret] from B, hub H does the following:
    i. Abort if P_{H} ∉ C_{H}[cid_{B}].Promisesₒᵤₜ;
    ii. Abort if Hash(secret) ≠ P_{H}.params.txHash;
    iii. Abort if now ≥ P_{H}.params.txExpiry;
    iv. R_{H} ← CreateReceipt(C_{H}[cid_{B}],sk_{H});
    v. Send [HubReceipt, R_{H}, P_{H}] to B;
    vi. Set (A,cid_{A},P_{A},_,_,_) ← PromiseMapping[P_{H}.params.txHash];
    vii. Send [ForwardHTLCSecret,P_{A},secret] to A.
  (c) Upon receiving [ForwardHTLCSecret,P_{A},secret] from H, client A does the
  following:
    i. Abort if P_{A} ∉ C_{A}[cid_{A}].Promisesₒᵤₜ;
    ii. Abort if Hash(secret) ≠ P_{A}.params.txHash;
    iii. Abort if now ≥ P_{A}.params.txExpiry;
    iv. R_{A} ← CreateReceipt(C_{A}[cid_{A}],P_{A},P_{A}.amount,sk_{A});
    v. Send [SenderReceipt, R_{A}, P_{A}] to H.
  (d) Upon receiving [SenderReceipt, R_{A},P_{A}] from A, hub H invokes
  VerifyReceipt(C_{H}[cid_{A}],R_{A},P_{A},P_{A}.amount,vk_{A}).
  (e) Upon receiving [HubReceipt, R_{H},P_{H}] from H, client B invokes
  VerifyReceipt(C_{B} [cid_{H}H],R_{H},P_{H},P_{H}.amount,vk_{A}).
CheckRegisterPromiseHTLC(C, P)
  (a) If P ∈ C.Promisesₒᵤₜ
    i. If C.contract.status = ″Closing″ remove P from C.Promisesₒᵤₜ
    ii. Output False;
  (b) If P.expiry < now, remove P from C.Promisesᵢₙ and output False;
  (c) If P ∈ registeredPromises:
    i. Invoke P.addr.RevealSecret(secret);
    ii. Remove P from registeredPromises and Promisesᵢₙ;
    iii. Output False;
  (d) If calling party has secret for P:
  i. If C.contract.status = ″Active″ and Pᵢₙ.expiry < (now + 3 × C.ledger.Δ), add
  P to registeredPromises and output True;
  ii. If C.contract.status = ″Closing″, add P to registeredPromises and output
  True;
    iii. Output False.
```

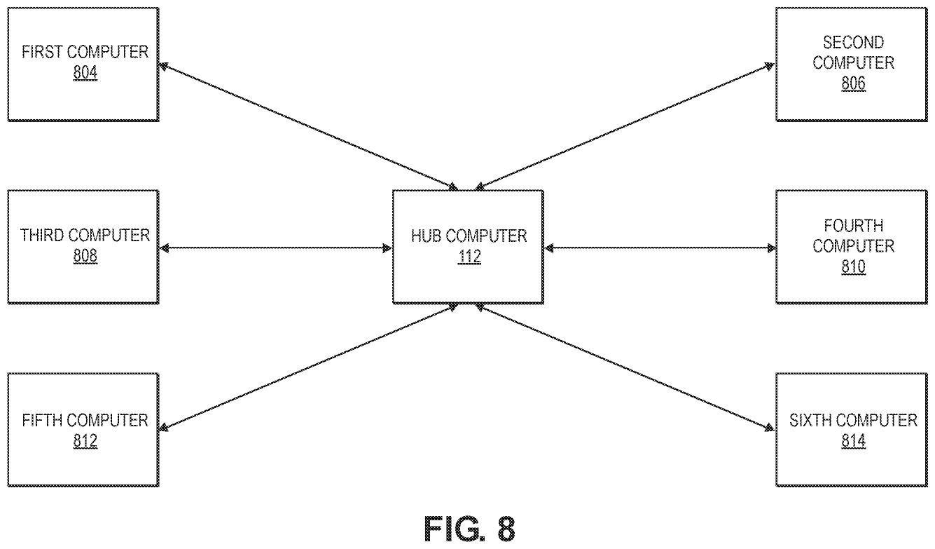

FIG. 8 shows a block diagram of a universal payment channel system according to embodiments. The universal payment channel system may comprise the hub computer 112. The hub computer 112 may communicate with a variety of computers, and may allow the computers to perform transactions between each other. For example, the first computer 804 may transmit payments to the second computer 806 via the hub computer 112. The hub computer 112 may facilitate payments between any two pairs of computers 804, 806, 808, 810, 812, 814 shown in FIG. 8 by establishing an interaction channel with each computer.

Embodiments of the disclosure have a number of advantages. For example, embodiments allow a user to perform blockchain interactions using their user device. Standard user devices can install applications managed by service providers. The service providers may perform blockchain operations on behalf of the user device, reducing the burden of computation from the user. Embodiments provide for an off-chain and cross-chain interactions. Embodiments deploy a smart contract to a blockchain network that implements an interaction channel between a user device via a service provider computer and a hub computer. The interaction channel can be used to transfer amounts of digital currencies to a smart contract. The transfers performed by the interaction channel need not be written to the blockchain network. Instead, a promise and receipt scheme are used, where a promise includes parameters of the smart contract at the time of a proposed transfer, and a receipt includes parameters of the smart contract after a proposed transfer is completed off-chain. The promise or the receipt can be used to write a transfer on-chain to the blockchain network.

Additionally, the channel contract includes executable bytecode (or generically, computer code). The bytecode can be utilized to apply rules, conditions, and/or additional processing that can dictate how the interaction is performed. For example, the bytecode can allow for the user device to both promise an amount, while being able to re-obtain the amount in the case of cancelling the interaction via the bytecode (e.g., the user is able to cancel a reservation at a hotel even though the funds have been promised).

Embodiments provide for a number of additional advantages. For example, the interaction channel does not need to be altered for use with new types of promise contracts. These promise contracts can provide bytecode that executes new types of interactions and any type of conditional functionality. The interaction channel provides the benefit of being versatile by being able to execute any promise contract.

Additionally, because the hub computer connects to a first user device and a second user device separately, the hub computer can provide for cross-chain payments. The hub computer can connect to the first user device using the first smart contract on the first blockchain network and connect to the second user device using the second smart contract on the second blockchain network. The hub computer may receive a first amount of a first type of digital currency via the first interaction channel established by the first smart contract and transfer a second amount of a second type of digital currency (equivalent in value to the first amount of the first type of digital currency) to the second smart contract via the second interaction channel.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a hub computer from a first computer, a sender message comprising a promise corresponding to a transaction comprising a promise type, an amount, a first verification key associated with the first computer, computer code, and a digital signature;
verifying, by the hub computer, the promise by at least verifying the digital signature using the first verification key, verifying that the amount is less than a first computer amount, and verifying that the hub computer is able to process the promise type; and
in response to verifying, executing the computer code to perform the transaction.

2. The method of claim 1, wherein the promise is a first promise, wherein the sender message further comprises a second verification key associated with a second computer, and wherein the method further comprises:
creating, by the hub computer, a second promise based on the first promise, wherein the second promise comprises the second verification key; and
sending, by the hub computer, the second promise to the second computer, wherein the second computer verifies the second promise.

3. The method of claim 2, further comprising:
obtaining, by the hub computer, a first channel contract for a first interaction channel between the hub computer and the first computer; and
obtaining, by the hub computer, a second channel contract for a second interaction channel between the hub computer and the second computer.

4. The method of claim 3 further comprising:
determining, by the hub computer, whether or not the first channel contract is expired; and
determining, by the hub computer, whether or not the second channel contract is expired.

5. The method of claim 3, wherein verifying the promise further comprises:
validating, by the hub computer, that the first computer has sufficient funds in the first channel contract for the amount in the promise.

6. The method of claim 5 further comprising:
adding, by the hub computer, the promise to a list of ingoing hub promises in the first channel contract; and
increasing, by the hub computer, a net ingoing hub promise value in the first channel contract by the amount.

7. The method of claim 3, wherein creating the second promise further comprises:
creating, by the hub computer, the second promise based on the second channel contract, a second promise type, a set of parameters, a hub computer private key, a hub computer verification key, and the second verification key, wherein the set of parameters includes the amount, a hash value, and an expiry time.

8. The method of claim 1, wherein prior to receiving the sender message, the method further comprises:
receiving, by the hub computer from the first computer, an enrollment request message comprising the first verification key;
determining, by the hub computer, whether or not the first computer is enrolled by verifying whether or not the first verification key is included in a list of enrolled verification keys;
enrolling, by the hub computer, the first service provider computer by adding the first verification key to the list of enrolled verification keys;
generating, by the hub computer, an enrollment response message indicating an enrollment status; and
providing, by the hub computer, the enrollment response message to the first computer.

9. The method of claim 2, wherein the sender message is received in a state channel formed between the hub computer and the first computer.

10. The method of claim 2, wherein after sending the second promise to the second computer, the method further comprises:
receiving, by the hub computer, the second promise and a secret from the second computer;
generating, by the hub computer, a second receipt for the second promise;
providing, by the hub computer, the second receipt and the second promise to the second computer;
providing, by the hub computer, the secret and the first promise to the first computer, wherein the first computer generates a first receipt and provides the first receipt to the hub computer, wherein the first receipt includes a first receipt digital signature created using a first computer private key;
receiving, by the hub computer, the first receipt from the first computer; and
verifying, by the hub computer, the first receipt by verifying the first receipt digital signature using the first verification key.

11. The method of claim 10, wherein the first promise and the second promise include an interaction hash value, wherein the method further comprises:
hashing, by the hub computer, the secret to form a derived hash value; and
comparing, by the hub computer, the derived hash value to the interaction hash value.

12. The method of claim 10, wherein generating the second receipt further comprises:
updating, by the hub computer, an outgoing hub credit value in a second channel contract based on the amount included in the second promise;
removing, by the hub computer, the second promise from a list of promises in the second channel contract; and
creating, by the hub computer, a second receipt digital signature based on the second promise using a hub computer private key, wherein the second receipt includes the second receipt digital signature.

13. The method of claim 1, wherein the computer code is bytecode, and wherein the bytecode is in a promise contract, wherein the method further comprises:
executing, by the hub computer, a resolve function in the bytecode of the promise contract when an interaction channel is closing between the first computer and the hub computer.

14. A hub computer comprising:
a processor; and
a computer-readable medium coupled to the processor, the computer-readable medium comprising code executable by the processor for implementing a method comprising:
receiving from a first computer, a sender message comprising a promise corresponding to a transaction comprising a promise type, an amount, a first verification key associated with the first computer, computer code, and a digital signature;
verifying the promise by at least verifying the digital signature using the first verification key, verifying that the amount is less than a first computer amount, and verifying that the hub computer is able to process the promise type; and
in response to verifying, executing the computer code to perform the transaction.

15. The hub computer of claim 14, wherein the promise is a first promise, wherein the sender message further comprises a second verification key associated with a second computer, wherein the computer code is bytecode, and wherein the method further comprises:
obtaining, by the hub computer, a first channel contract for a first interaction channel between the hub computer and the first computer;
determining, by the hub computer, whether or not the first channel contract is expired;
obtaining, by the hub computer, a second channel contract for a second interaction channel between the hub computer and the second computer;
determining, by the hub computer, whether or not the second channel contract is expired;
creating, by the hub computer, a second promise based on the first promise, wherein the second promise comprises the second verification key; and
sending, by the hub computer, the second promise to the second computer, wherein the second computer verifies the second promise.

16. The hub computer of claim 15, wherein the first promise includes an interaction hash value, the method further comprises:
receiving, by the hub computer, the second promise and a secret from the second computer;
hashing, by the hub computer, the secret to form a derived hash value;
comparing, by the hub computer, the derived hash value to the interaction hash value;
generating, by the hub computer, a second receipt for the second promise, wherein the second promise includes the interaction hash value;
providing, by the hub computer, the second receipt and the second promise to the second computer;
providing, by the hub computer, the secret and the first promise to the first computer, wherein the first computer generates a first receipt comprising a first receipt digital signature and provides the first receipt to the hub computer;
receiving, by the hub computer, the first receipt from the first computer; and
verifying, by the hub computer, the first receipt by verifying the first receipt digital signature using the first verification key.

17. A method comprising:
establishing, by a first computer, an interaction channel with a hub computer, wherein the interaction channel corresponds to a channel contract;
generating, by the first computer, a sender message comprising a first promise corresponding to a transaction comprising a promise type, an amount, a first verification key associated with the first computer, computer code, and a digital signature; and
providing, by the first computer, the sender message to the hub computer, wherein the hub computer verifies the first promise, executes the computer code to perform the transaction.

18. The method of claim 17, wherein the interaction channel is a first interaction channel, wherein the channel contract is a first channel contract, wherein the hub computer establishes a second interaction channel between the hub computer and a second computer, wherein the second interaction channel corresponds to a second channel contract, and wherein the first interaction channel and the second interaction channel are state channels.

19. The method of claim 17, wherein the computer code is bytecode and wherein the method further comprises:
closing, by the first computer, the interaction channel, wherein the bytecode is in a promise contract, wherein the hub computer executes a resolve function in the bytecode of the promise contract when the interaction channel is closing between the first computer and the hub computer.

20. The method of claim 17 further comprising:
receiving, by the first computer, a secret and the first promise from the hub computer;
hashing, by the first computer, the secret to obtain a derived hash value;
comparing, by the first computer, the derived hash value to a hash value included in a set of parameters in the first promise;
if the hashed secret matches the hash value, generating, by the first computer, a first receipt based on the first promise; and
providing, by the first computer, the first receipt to the hub computer.
